(19) United States
(12) Patent Application Publication
(10) Pub. No.: US 2025/0211969 A1
(43) Pub. Date: Jun. 26, 2025

(54) ELECTRONIC DEVICE FOR SUPPORTING MULTI-SIM, AND ELECTRONIC DEVICE OPERATING METHOD

(71) Applicant: Samsung Electronics Co., Ltd., Suwon-si (KR)

(72) Inventors: Hyejeong KIM, Suwon-si (KR); Ansik SHIN, Suwon-si (KR)

(21) Appl. No.: 19/078,949

(22) Filed: Mar. 13, 2025

Related U.S. Application Data
(63) Continuation of application No. PCT/KR2023/009128, filed on Jun. 29, 2023.

(30) Foreign Application Priority Data
Sep. 16, 2022 (KR) 10-2022-0117330
Sep. 27, 2022 (KR) 10-2022-0122546

(51) Int. Cl. H04W 8/18; H04L 67/61

(52) U.S. Cl. CPC H04W 8/18; H04L 67/61

(57) ABSTRACT

An electronic device and an operating method thereof are provided. The electronic device includes a first subscriber identity module to store a first profile associated with a first cellular network, a second subscriber identity module to store a second profile associated with a second cellular network, an application processor, a communication circuit configured to support transmission or reception of data through at least one cellular network among the first cellular network and the second cellular network, memory storing one or more computer programs, and a communication processor communicatively coupled to the first subscriber identity module, the second subscriber identity module, the application processor, the communication circuit, and the memory, wherein the one or more computer programs include computer-executable instructions that, when executed by the communication processor individually or collectively, cause the electronic device to receive, while being connected to the first cellular network, a request for activating the second cellular network from the application processor so as to carry out a service provided by a second application having a priority higher than a priority of a first application carrying out a service through the first cellular network, determine whether there is a combination of connectable frequency bands among combinations of frequency bands that allow the communication circuit to perform data transmission through the first cellular network and data transmission through the second cellular network, release a connection to a first communication network, and activate a connection to a second communication network based on determining that there is no combination of connectable frequency bands.

### CROSS-REFERENCE TO RELATED APPLICATION(S)

This application is a continuation application, claiming priority under U.S.C. § 365 (c), of an International application No. PCT/KR2023/009128, filed on Jun. 29, 2023, which is based on and claims the benefit of a Korean patent application number 10-2022-0117330, filed on Sep. 16, 2022, in the Korean Intellectual Property Office, and of a Korean patent application number 10-2022-0122546, filed on Sep. 27, 2022, in the Korean Intellectual Property Office, the disclosure of each of which is incorporated by reference herein in its entirety.

### BACKGROUND

### 1. Field

The disclosure relates to an electronic device and operation method thereof. More particularly, the disclosure relates to an electronic device supporting multiple subscriber identity modules (SIM) s.

### 2. Description of Related Art

In order to meet the increasing demand for wireless data traffic since the commercialization of 4th generation (4G) communication systems, efforts are being made to develop improved 5th generation (5G) communication systems or pre-5G communication systems. For this reason, the 5G communication system or pre-5G communication system is also called “beyond 4G network” or “post long-term evolution (LTE) system”. To achieve high data rates, 5G communication systems are being considered for implementation also in the extremely high frequency (millimeter wave (mm Wave)) band (e.g., above-6 GHz bands) in addition to the bands used by LTE (sub-6 GHz bands). Various technologies including beamforming, massive multiple-input multiple-output (massive MIMO), full dimensional MIMO (FD-MIMO), array antennas, analog beamforming, and large scale antennas are considered for 5G communication systems.

A fifth generation mobile communication system may support a non-standalone (NSA) mode for transmitting or receiving data to or from a base station of the fourth generation cellular communication and a base station of the fifth generation cellular communication, or a standalone (SA) mode for transmitting or receiving data to or from a base station of the fifth generation cellular communication.

If an electronic device supports multiple SIMs, it may be connected to at least two cellular networks. While the electronic device is being connected to one cellular network, to connect to another cellular network, an operation may be requested to allocate radio frequency (RF) resources to a subscriber identity module corresponding to the cellular network to be connected. The electronic device may perform an operation to connect to another cellular network by using the allocated RF resources.

The above information is presented as background information only to assist with an understanding of the disclosure. No determination has been made, and no assertion is made, as to whether any of the above might be applicable as prior art with regard to the disclosure.

### SUMMARY

When an electronic device is connected to at least two cellular networks, it can transmit and/or receive data to or from at least two cellular networks simultaneously.

However, due to limitations in the performance of the communication circuit of the electronic device, data can be transmitted simultaneously to at least two cellular networks through a combination of some frequency bands. In a situation where the electronic device is unable to connect to cellular networks through a combination of some frequency bands, if it is requested to transmit and/or receive data to or from at least two cellular networks, an application or real-time service requiring low latency may be not executed due to execution of an application that may smoothly operate even with relatively high latency.

Aspects of the disclosure are to address at least the above-mentioned problems and/or disadvantages and to provide at least the advantages described below. Accordingly, an aspect of the disclosure is to provide an electronic device supporting multiple subscriber identity modules (SIM) s.

Additional aspects will be set forth in part in the description which follows and, in part, will be apparent from the description, or may be learned by practice of the presented embodiments.

In accordance with an aspect of the disclosure, an electronic device is provided. The electronic device includes a first subscriber identity module to store a first profile associated with a first cellular network, a second subscriber identity module to store a second profile associated with a second cellular network, an application processor, a communication circuit configured to support transmission or reception of data through at least one cellular network among the first cellular network and the second cellular network, memory storing one or more computer programs, and a communications processor communicatively coupled to the first subscriber identity module, the second subscriber identity module, the application processor, the communication circuit, and the memory, wherein the one or more computer programs include computer-executable instructions that, when executed by the communication processor individually or collectively, cause the electronic device to receive, while being connected to the first cellular network, a request for activating the second cellular network from the application processor so as to carry out a service provided by a second application having a higher priority than the priority of a first application carrying out a service through the first cellular network, determine whether there is a combination of connectable frequency bands among combinations of frequency bands that allow the communication circuit to perform data transmission through the first cellular network and data transmission through the second cellular network simultaneously, and release the connection to a first communication network, and activate the connection to a second communication network based on determining that there is no combination of connectable frequency bands.

In accordance with another aspect of the disclosure, a method of operating the electronic device is provided. The method includes receiving, by the electronic device, while being connected to a first cellular network, a request for activating a second cellular network from an application processor so as to carry out a service provided by a second application having a higher priority than the priority of a first application carrying out a service through the first cellular network, determining, by the electronic device, whether there is a combination of connectable frequency bands among combinations of frequency bands that allow a communication circuit to perform data transmission through the first cellular network and data transmission through the second cellular network simultaneously, and releasing, by the electronic device, a connection to a first communication network and activating a connection to a second communication network based on determining that there is no combination of connectable frequency bands.

In accordance with another aspect of the disclosure, one or more non-transitory computer-readable storage media storing one or more computer programs including computer-executable instructions that, when executed by a communications processor of an electronic device individually or collectively, cause the electronic device to perform operations are provided. The operations include receiving, by the electronic device, while being connected to a first cellular network, a request for activating a second cellular network from an application processor so as to carry out a service provided by a second application having a higher priority than a priority of a first application carrying out a service through the first cellular network, determining, by the electronic device, whether there is a combination of connectable frequency bands among combinations of frequency bands that allow a communication circuit to perform data transmission through the first cellular network and data transmission through the second cellular network simultaneously, and releasing, by the electronic device, a connection to the first communication network and activating a connection to the second communication network based on determining that there is no combination of connectable frequency bands.

The electronic device and operation method thereof according to various embodiments of the disclosure can, based on the fact that there is no combination of connectable frequency bands among combinations of frequency bands in which data transmission through a first cellular network and data transmission through a second cellular network can be performed simultaneously, release the connection to the cellular network used by a relatively low priority application and activate the connection to the cellular network used by a relatively high priority application. Hence, the electronic device may prevent a situation in which it cannot execute an application requiring low latency or a real-time service when data transmission cannot be performed through frequency bands that enable data transmission through a first cellular network and data transmission through a second cellular network simultaneously.

The electronic device and operation method thereof according to various embodiments of the disclosure can provide a user interface that enables an application using a first cellular network and an application using a second cellular network to be executed simultaneously and the execution screens to be displayed together. Hence, the electronic device, if capable of supporting multiple SIMs, can provide the user with the usability of using two independent electronic devices on a single electronic device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram of an electronic device for supporting legacy network communication and 5G network communication according to an embodiment of the disclosure;

FIG. 3 is a diagram illustrating a structure of protocol stacks in a network 100 of legacy communication and/or 5G communication according to an embodiment of the disclosure;

FIGS. 4A, 4B and 4C are diagrams illustrating wireless communication systems providing a network of legacy communication and/or 5G communication according to various embodiments of the disclosure;

FIG. 5 is a diagram illustrating an electronic device according to an embodiment of the disclosure;

FIG. 6 is a diagram illustrating a hierarchical structure for simultaneous data transmission through a first cellular network and a second cellular network in an electronic device according to an embodiment of the disclosure;

FIG. 7A is a diagram illustrating an embodiment in which an electronic device operates in first mode according to an embodiment of the disclosure;

FIG. 7B is a diagram illustrating an embodiment in which an electronic device operates in second mode according to an embodiment of the disclosure;

FIG. 8A is a diagram illustrating an embodiment in which an electronic device performs a series of operations for operating in second mode upon booting according to an embodiment of the disclosure;

FIG. 8B is a diagram illustrating an embodiment in which an electronic device in second mode selects one of a first cellular network and a second cellular network and transmits data through a selected cellular network according to an embodiment of the disclosure;

FIG. 8C is a diagram illustrating an embodiment in which an electronic device updates a table for selecting a cellular network to transmit data according to installation or deletion of an application according to an embodiment of the disclosure;

FIG. 9 is a flowchart illustrating operations of an electronic device depending upon a presence of frequency bands enabling data transmission/reception through a first cellular network and data transmission/reception through a second cellular network simultaneously according to an embodiment of the disclosure;

FIG. 10 is a flowchart illustrating operations for activating a connection to a second cellular network in response to execution of an application having a relatively high priority in an electronic device according to an embodiment of the disclosure;

FIG. 11 is a flowchart illustrating operations for activating a connection to a second cellular network in response to execution of an application having a relatively low priority in an electronic device according to an embodiment of the disclosure; and

FIG. 12 is a flowchart illustrating an operation method of an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

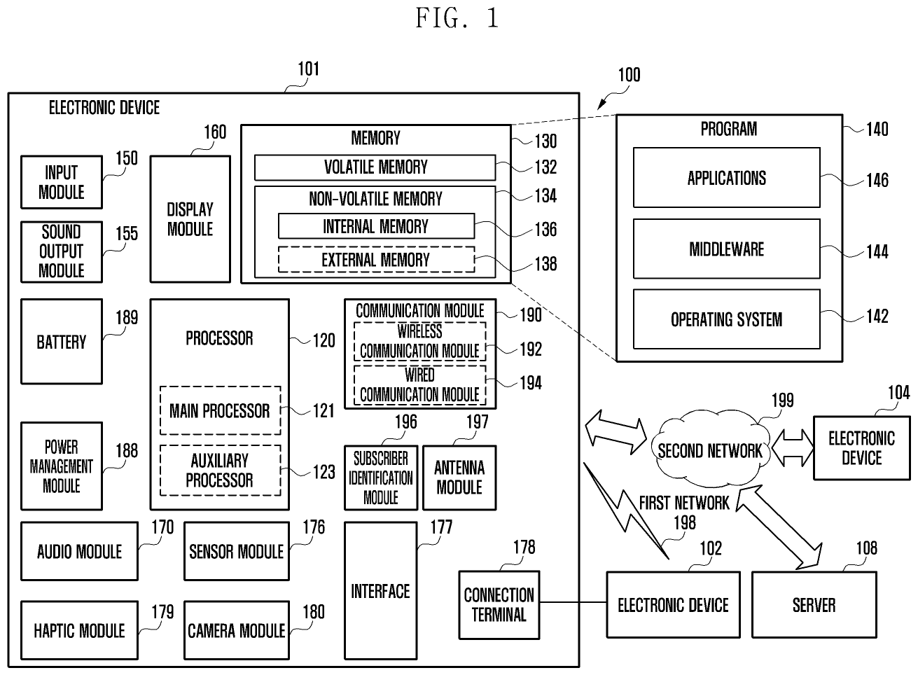

FIG. 1 is a block diagram illustrating an electronic device in a network environment according to an embodiment of the disclosure.

Referring to FIG. 1, an electronic device 101 in the network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mm Wave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

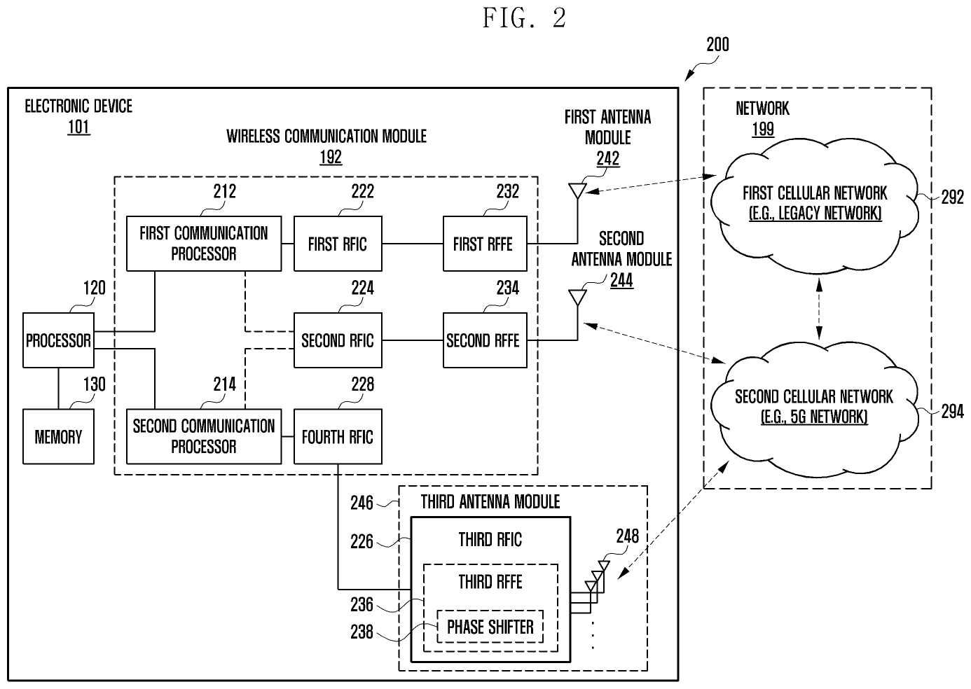

FIG. 2 is a block diagram 200 of an electronic device 101 for supporting legacy network communication and 5G network communication according to an embodiment of the disclosure.

Referring to FIG. 2, the electronic device 101 may include a first communication processor 212, a second communication processor 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, and an antenna 248. The electronic device 101 may further include the processor 120 and the memory 130. The network 199 may include a first network 292 and a second network 294. According to another embodiment of the disclosure, the electronic device 101 may further include at least one component among the components illustrated in FIG. 1, and the network 199 may further include at least one other network. According to an embodiment of the disclosure, the first communication processor 212, the second communication processor 214, the first RFIC 222, the second RFIC 224, the fourth RFIC 228, the first RFFE 232, and the second RFFE 234 may be included as at least a part of the wireless communication module 192. According to another embodiment of the disclosure, the fourth RFIC 228 may be omitted or may be included as a part of the third RFIC 226.

The first communication processor 212 may establish a communication channel of a band to be used for wireless communication with the first network 292, and may support legacy network communication via the established communication channel. According to embodiments of the disclosure, the first network may be a legacy network including 2G, 3G, 4G, or long term evolution (LTE) network. The second communication processor 214 may establish a communication channel corresponding to a designated band (e.g., approximately 6 GHz to 60 GHz) among bands to be used for wireless communication with the second network 294, and may support 5G network communication via the established channel. According to certain embodiments of the disclosure, the second network 294 may be a 5G network defined in 3GPP. Additionally, according to an embodiment of the disclosure, the first communication processor 212 or the second communication processor 214 may establish a communication channel corresponding to another designated band (e.g., lower than 6 GHz) among bands to be used for wireless communication with the second network 294, and may support 5G network communication via the established channel. According to an embodiment of the disclosure, the first communication processor 212 and the second communication processor 214 may be implemented in a single chip or a single package. According to certain embodiments of the disclosure, the first communication processor 212 or the second communication processor 214 may be implemented in a single chip or a single package, together with the processor 120, the sub-processor 123, or the communication module 190.

In the case of transmission, the first RFIC 222 may convert a baseband signal generated by the first communication processor 212 into a radio frequency (RF) signal in a range of approximately 700 MHz to 3 GHz used for the first network 292 (e.g., a legacy network). In the case of reception, an RF signal is obtained from the first network 292 (e.g., a legacy network) via an antenna (e.g., the first antenna module 242), and may be preprocessed via an RFFE (e.g., the first RFFE 232). The first RFIC 222 may convert the preprocessed RF signal to a baseband signal so that the base band signal is processed by the first communication processor 212.

In the case of transmission, the second RFIC 224 may convert a baseband signal generated by the first communication processor 212 or the second communication processor 214 into an RF signal (hereinafter, a 5G Sub6 RF signal) of a Sub6 band (e.g., lower than 6 GHz) used for the second network 294 (e.g., 5G network). In the case of reception, a 5G Sub6 RF signal is obtained from the second network 294 (e.g., a 5G network) via an antenna (e.g., the second antenna module 244), and may preprocessed by an RFFE (e.g., the second RFFE 234). The second RFIC 224 may convert the preprocessed 5G Sub6 RF signal into a baseband signal so that the baseband signal is processed by a corresponding communication processor from among the first communication processor 212 or the second communication processor 214.

The third RFIC 226 may convert a baseband signal generated by the second communication processor 214 into an RF signal (hereinafter, a 5G Above6 RF signal) of a 5G Above6 band (e.g., approximately 6 GHz to 60 GHz) to be used for the second network 294 (e.g., 5G network). In the case of reception, a 5G Above6 RF signal is obtained from the second network 294 (e.g., a 5G network) via an antenna (e.g., the antenna 248), and may be preprocessed by the third RFFE 236. The third RFIC 226 may convert the preprocessed 5G Above6 RF signal to a baseband signal so that the base band signal is processed by the second communication processor 214. According to an embodiment of the disclosure, the third RFFE 236 may be implemented as a part of the third RFIC 226.

According to an embodiment of the disclosure, the electronic device 101 may include the fourth RFIC 228, separately from or as a part of the third RFIC 226. In this instance, the fourth RFIC 228 may convert a baseband signal generated by the second communication processor 214 into an RF signal (hereinafter, an IF signal) in an intermediate frequency band (e.g., approximately 9 GHz to 11 GHZ), and may transfer the IF signal to the third RFIC 226. The third RFIC 226 may convert the IF signal to a 5G Above6 RF signal. In the case of reception, a 5G Above6 RF signal is received from the second network 294 (e.g., a 5G network) via an antenna (e.g., the antenna 248), and may be converted into an IF signal by the third RFFE 226. The fourth RFIC 228 may convert the IF signal to a baseband signal so that the base band signal is processed by the second communication processor 214.

According to an embodiment of the disclosure, the first RFIC 222 and the second RFIC 224 may be implemented as a single chip or at least a part of the single package. According to an embodiment of the disclosure, the first RFFE 232 and the second RFFE 234 may be implemented as a single chip or at least a part of the single package. According to an embodiment of the disclosure, at least one antenna module of the first antenna module 242 or the second antenna module 244 may be omitted, or may be combined with another antenna module so as to process RF signals in a plurality of bands.

According to an embodiment of the disclosure, the third RFIC 226 and the antenna 248 may be disposed in the same substrate, and may form the third antenna module 246. For example, the wireless communication module 192 or the processor 120 may be disposed in a first substrate (e.g., main PCB). In this instance, the third RFIC 226 is disposed in a part (e.g., a lower part) of the second substrate (e.g., a sub PCB) separate from the first substrate and the antenna 248 is disposed on another part (e.g., an upper part), so that the third antenna module 246 is formed. By disposing the third RFIC 226 and the antenna 248 in the same substrate, the length of a transmission line therebetween may be reduced. For example, this may reduce a loss (e.g., attenuation) of a signal in a high-frequency band (e.g., approximate 6 GHz to 60 GHz) used for 5G network communication, the loss being caused by a transmission line. Accordingly, the electronic device 101 may improve the quality or speed of communication with the second network 294 (e.g., 5G network).

According to an embodiment of the disclosure, the antenna 248 may be implemented as an antenna array including a plurality of antenna elements which may be used for beamforming. In this instance, the third RFIC 226 may be, for example, a part of the third RFFE 236, and may include a plurality of phase shifters 238 corresponding to a plurality of antenna elements. In the case of transmission, each of the plurality of phase shifters 238 may shift the phase of a 5G Above6RF signal to be transmitted to the outside of the electronic device 101 (e.g., a base station of a 5G network) via a corresponding antenna element. In the case of reception, each of the plurality of phase shifters 238 may shift the phase of the 5G Above6 RF signal received from the outside via a corresponding antenna element into the same or substantially the same phase. This may enable transmission or reception via beamforming between the electronic device 101 and the outside.

The second network 294 (e.g., 5G network) may operate independently (e.g., stand-along (SA)) from the first network 292 (e.g., a legacy network), or may operate by being connected thereto (e.g., non-stand alone (NSA)). For example, in the 5G network, only an access network (e.g., 5G radio access network (RAN) or next generation RAN (NG RAN)) may exist, and a core network (e.g., next generation core (NGC)) may not exist. In this instance, the electronic device 101 may access an access network of the 5G network, and may access an external network (e.g., the Internet) under the control of the core network (e.g., an evolved packed core (EPC)) of the legacy network. Protocol information (e.g., LTE protocol information) for communication with the legacy network or protocol information (e.g., New Radio (NR) protocol information) for communication with the 5G network may be stored in the memory 230, and may be accessed by another component (e.g., the processor 120, the first communication processor 212, or the second communication processor 214).

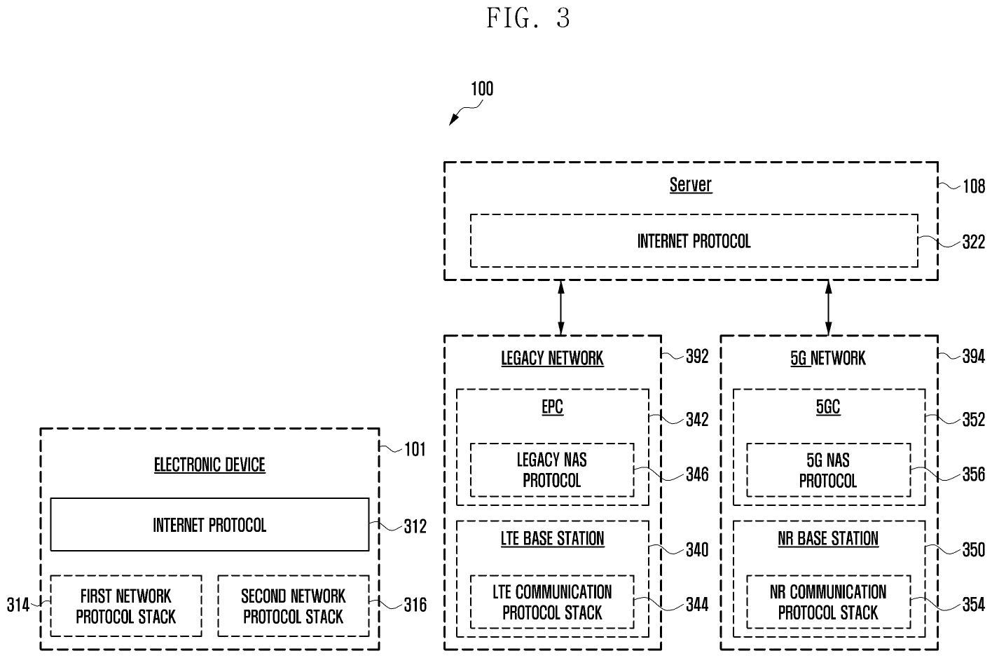

FIG. 3 illustrates a protocol stack structure of a network 100 of legacy communication and/or 5G communication according to an embodiment of the disclosure.

Referring to FIG. 3, the network 100 according to an illustrated embodiment may include the electronic device 101, a legacy network 392, a 5G network 394, and the server 108.

The electronic device 101 may include an Internet protocol 312, a first communication protocol stack 314, and a second communication protocol stack 316. The electronic device 101 may communicate with the server 108 through the legacy network 392 and/or the 5G network 394.

According to an embodiment of the disclosure, the electronic device 101 may perform Interne communication associated with the server 108 through the Internet protocol 312 (for example, a TCP, a UDP, or an IP). The Internet protocol 312 may be executed by, for example, a main processor (for example, the main processor 121 of FIG. 1) included in the electronic device 101.

According to another embodiment of the disclosure, the electronic device 101 may perform wireless communication with the legacy network 392 through the first communication protocol stack 314. According to another embodiment of the disclosure, the electronic device 101 may perform wireless communication with the 5G network 394 through the second communication protocol stack 316. The first communication protocol stack 314 and the second communication protocol stack 316 may be executed by, for example, one or more communication processors (for example, the wireless communication module 192 of FIG. 1) included in the electronic device 101.

The server 108 may include an Internet protocol 322. The server 108 may transmit and receive data related to the Internet protocol 322 to and from the electronic device 101 through the legacy network 392 and/or the 5G network 394. According to an embodiment of the disclosure, the server 108 may include a cloud computing server existing outside the legacy network 392 or the 5G network 394. According to another embodiment of the disclosure, the server 108 may include an edge computing server (or a mobile edge computing (MEC) server) located inside at least one of the legacy network or the 5G network 394.

The legacy network 392 may include an LTE eNode B (eNB) 340 and an EPC 342. The LTE eNB 340 may include an LTE communication protocol stack 344. The EPC 342 may include a legacy NAS protocol 346. The legacy network 392 may perform LTE wireless communication with the electronic device 101 through the LTE communication protocol stack 344 and the legacy NAS protocol 346.

The 5G network 394 may include an NR gNB 350 and a 5GC 352. The NR gNB 350 may include an NR communication protocol stack 354. The 5GC 352 may include a 5G NAS protocol 356. The 5G network 394 may perform NR wireless communication with the electronic device 101 through the NR communication protocol stack 354 and the 5G NAS protocol 356.

According to an embodiment of the disclosure, the first communication protocol stack 314, the second communication protocol stack 316, the LTE communication protocol stack 344, and the NR communication protocol stack 354 may include a control plane protocol for transmitting and receiving a control message and a user plane protocol for transmitting and receiving user data. The control message may include a message related to at least one of, for example, security control, bearer setup, authentication, registration, or mobility management. The user data may include, for example, the remaining data except other than the control message.

According to an embodiment of the disclosure, the control plane protocol and the user plane protocol may include a physical (PHY) layer, a medium access control (MAC) layer, a radio link control (RLC) layer, or a packet data convergence protocol (PDCP) layer. The PHY layer may channel-code and modulate data received from, for example, a higher layer (for example, the MAC layer), transmit the data through a radio channel, demodulate and decode the data received through the radio channel, and transmit the data to the higher layer. The PHY layer included in the second communication protocol stack 316 and the NR communication protocol stack 354 may further perform an operation related to beamforming. The MAC layer may logically/physically map, for example, data to a radio channel for transmitting and receiving the data and perform a hybrid automatic repeat request (HARQ) for error correction. The RLC layer may perform, for example, data concatenation, segmentation, or reassembly, and data sequence identification, reordering, or duplication detection. The PDCP layer may perform an operation related to, for example, ciphering of a control message and user data and data integrity. The second communication protocol stack 316 and the NR communication protocol stack 354 may further include a service data adaptation protocol (SDAP). The SDAP may manage allocation of radio bearers based on quality of service (QOS) of user data.

According to certain embodiments of the disclosure, the control plane protocol may include a radio resource control (RRC) layer and a non-access stratum (NAS) layer. The RRC layer may process control, for example, data related to radio bearer setup, paging, or mobility management. The NAS may process, for example, a control message related to authentication, registration, or mobility management.

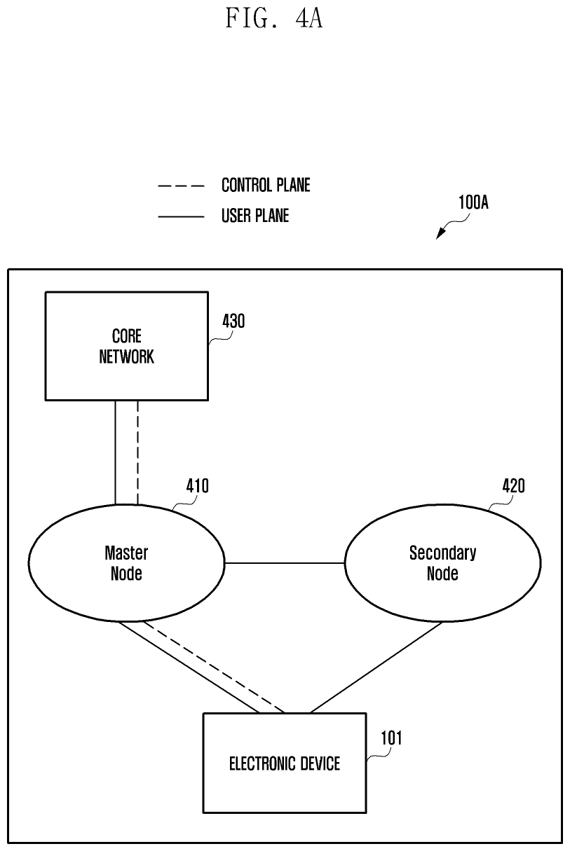

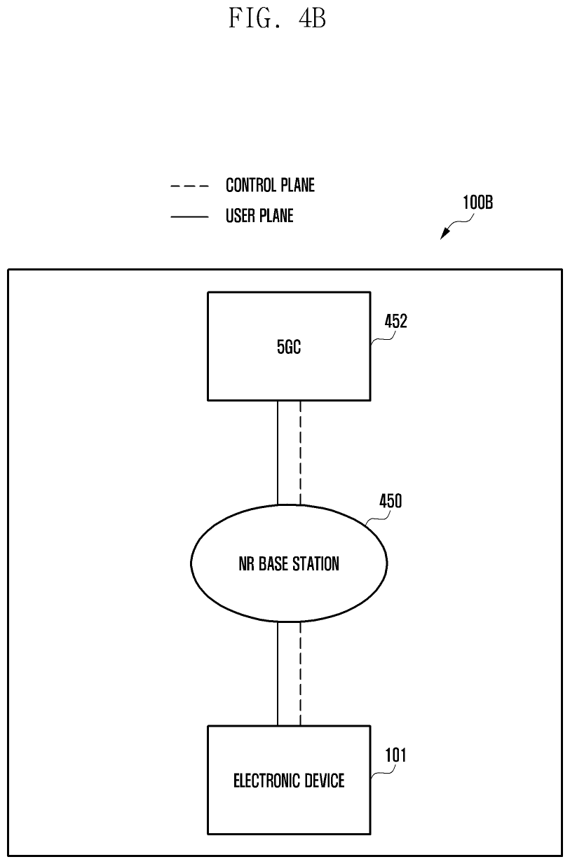

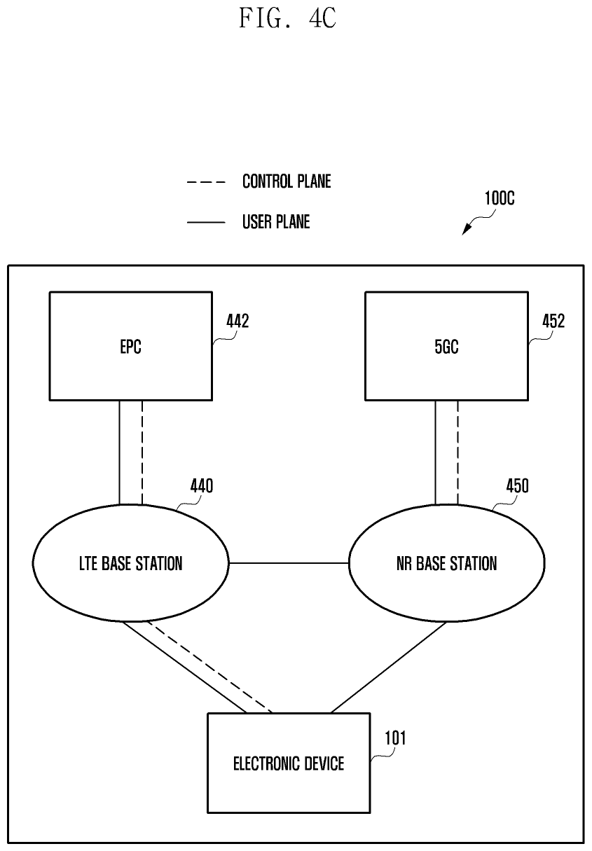

FIG. 4A illustrates a wireless communication system providing a network of legacy communication and/or 5G communication according to an embodiment of the disclosure. FIG. 4B illustrates a wireless communication system providing a network of legacy communication and/or 5G communication according to an embodiment of the disclosure. FIG. 4C illustrates a wireless communication system providing a network of legacy communication and/or 5G communication according to an embodiment of the disclosure. Referring to FIGS. 4A, 4B, and 4C, network environments 100A, 100B, and 100C may include at least one of a legacy network and a 5G network. The legacy network may include, for example, a 4G or LTE eNB 450 (for example, an eNodeB (eNB)) of the 3GPP standard supporting radio access with the electronic device 101 and an evolved packet core (EPC) 451 for managing 4G communication. The 5G network may include, for example, a new radio (NR) gNB 450 (for example, a gNodeB (gNB)) supporting radio access with the electronic device 101 and a 5th generation core (5GC) 452 for managing 5G communication of the electronic device 101.

According to certain embodiments of the disclosure, the electronic device 101 may transmit and receive a control message and user data through legacy communication and/or 5G communication. The control message may include, for example, a control message related to at least one of security control of the electronic device 101, bearer setup, authentication, registration, or mobility management. The user data may be, for example, user data other than a control message transmitted and received between the electronic device 101 and a core network 430 (for example, the EPC 442).

Referring to FIG. 4A, the electronic device 101 according to an embodiment may transmit and receive at least one of a control message or user data to and from at least some of the 5G network (for example, the NR gNB 450 and the 5GC 452) using at least some of the legacy network (for example, the LTE eNB 440 and the EPC 442).

According to certain embodiments of the disclosure, the network environment 100A may include a network environment for providing wireless communication dual connectivity (multi-radio access technology (RAT) dual connectivity (MR-DC)) to the LTE eNB 440 and the NR gNB 450 and transmitting and receiving a control message to and from the electronic device 101 through one core network 430 of the EPC 442 or the 5GC 452.

According to certain embodiments of the disclosure, one of the MR-DC environment, the LTE eNB 440 or the NR gNB 450 may operate as a master node (MN) 410, and the other may operate as a secondary node (SN) 420. The MN 410 may be connected to the core network 430 and transmit and receive a control message. The MN 410 and the SN 420 may be connected to each other through a network interface and transmit and receive a message related to radio resource (for example, communication channel) management.

According to certain embodiments of the disclosure, the MN 410 may include the LTE eNB 450, the SN 420 may include the NR gNB 450, and the core network 430 may include the EPC 442. For example, a control message may be transmitted and received through the LTE eNB 440 and the EPC 442, and user data may be transmitted and received through the LTE eNB 450 and the NR gNB 450.

Referring to FIG. 4B, according to certain embodiments of the disclosure, the 5G network may independently transmit and receive a control message and user data to and from the electronic device 101.

Referring to FIG. 4C, the legacy network and the 5G network according to certain embodiments may independently provide data transmission and reception. For example, the electronic device 101 and the EPC 442 may transmit and receive a control message and user data through the LTE eNB 450. According to another embodiment of the disclosure, the electronic device 101 and the 5GC 452 may transmit and receive a control message and user data through the NR gNB 450.

According to certain embodiments of the disclosure, the electronic device 101 may be registered in at least one of the EPC 442 or the 5GC 450 and transmit and receive a control message.

According to certain embodiments of the disclosure, the EPC 442 or the 5GC 452 may interwork and manage communication of the electronic device 101. For example, movement information of the electronic device 101 may be transmitted and received through an interface between the EPC 442 and the 5GC 452.

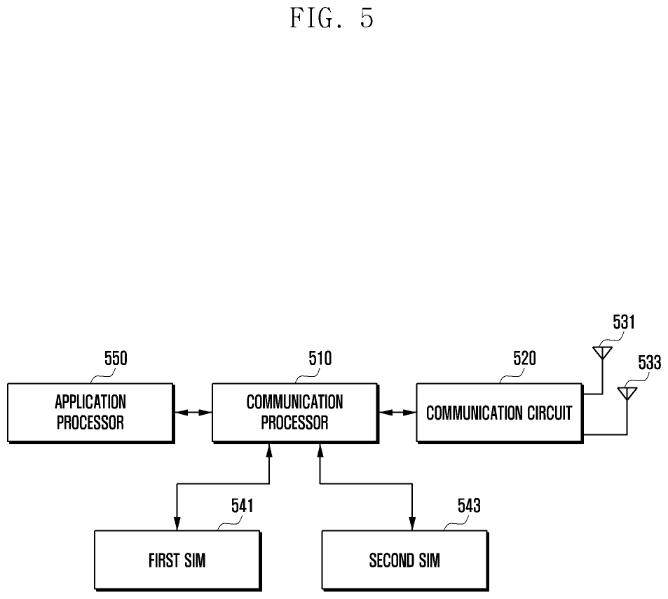

FIG. 5 is a block diagram illustrating an electronic device according to an embodiment of the disclosure.

Referring to FIG. 5, the electronic device (e.g., electronic device 101 in FIG. 1) according to various embodiments of the disclosure may include a communication processor 510, a communication circuit 520, a first antenna 531, a second antenna 533, a first subscriber identity module (SIM) 541, a second subscriber identity module 543, and/or an application processor 550.

The communication processor 510 may perform various operations for wireless communication on a cellular network. For example, the communication processor 510 may support establishment of a communication channel in a band to be used for wireless communication with a cellular network and wireless communication through the established communication channel.

The communication circuit 520 may receive a signal radiated from the outside through the first antenna 531 and/or the second antenna 533, or may radiate a signal output from the communication processor 510 through the first antenna 531 and/or the second antenna 533, under the control of the communication processor 510. The communication circuit 520 may include a transceiver and one or more RF chains for processing signals. The RF chain may include an amplifier that amplifies a signal output from the transceiver and transfers it to the first antenna 531 and/or the second antenna 533, and a low-noise amplifier (LNA) that amplifies a signal received through the first antenna 531 and/or the second antenna 533 and transfers the amplified signal to the transceiver.

The transceiver may perform various operations for processing a signal received from the communication processor 510. For example, the transceiver may perform a modulation operation on a signal received from the communication processor 510. For example, the transceiver may perform a frequency modulation operation to convert a baseband signal into a radio frequency (RF) signal used for cellular communication. The transceiver may also perform a demodulation operation on a signal received through the first antenna 531 and/or the second antenna 533 from the outside. For example, the transceiver may perform a frequency demodulation operation to convert a radio frequency (RF) signal into a baseband signal.

The subscriber identity module (SIM) 541 or 543 may store identification information (e.g., international mobile subscriber identity (IMSI)) for connection, authentication, charging, security, or the like on a cellular network. The electronic device 101 may identify the identification information stored in the first subscriber identity module 541 and/or the second subscriber identity module 543 and transmit it to the base station during a process of connecting to a cellular network (e.g., registration procedure).

The subscriber identity module 512 or 514 may be made of an IC card and may be mounted on a slot provided in the electronic device 101. According to another embodiment of the disclosure, at least one of the subscriber identity modules 541 and 543 may be implemented as an embedded-SIM (or, embedded universal integrated circuit card (eUICC)) directly embedded in the electronic device 101. When the subscriber identity module 541 or 543 is implemented as an embedded-SIM, a security chip for storing the subscriber identity module 541 or 543 is soldered on the circuit board of the electronic device 101 during the manufacturing process, and then it may be mounted on the user terminal through remote SIM provisioning.

The electronic device 101 may include at least two subscriber identity modules. This document describes, without being limited to, an embodiment in which the electronic device 101 includes two subscriber identity modules (e.g., first subscriber identity module 541 and second subscriber identity module 543).

The electronic device 101 may perform wireless communication with a first cellular network and a second cellular network operated by different network operators (or, mobile communication companies) by using the first subscriber identity module 541 and the second subscriber identity module 543. For example, when connecting to the first cellular network, the communication processor 510 may wirelessly connect to a base station of the first cellular network by using first identification information stored in the first subscriber identity module 541, and when connecting to the second cellular network, the communication processor 510 may wirelessly connect to a base station of the second cellular network by using second identification information stored in the second subscriber identity module 543.

The first cellular network and/or the second cellular network may be one of various mobile communication networks. According to an embodiment of the disclosure, the first cellular network and the second cellular network may be either a 4th generation mobile communication network (LTE) or a 5th generation cellular communication network (new radio, NR). According to another embodiment of the disclosure, the first cellular network may be a network supporting EN-DC (EUTRA-NR-Dual-Connectivity). An EN-DC or NSA (non-standalone) system may provide uplink and/or downlink transmission by using two radio access technologies (RATs). The electronic device 500 connected to the first cellular network supporting EN-DC may utilize resources of a 4G LTE cellular network and a 5G NR cellular network simultaneously.

The communication processor 510 may connect to and stand by for the first cellular network and the second cellular network simultaneously by using the first subscriber identity module 541 and the second subscriber identity module 543 (dual SIM dual standby, DSDS). The communication processor 510 may perform data communication for data transmission or reception by using one of the first cellular network and the second cellular network. The mode for performing data communication by using one of the first cellular network and the second cellular network may be defined as the first mode.

In this case, the communication processor 510 may perform data communication through one cellular network and may not perform data communication through the other cellular network (or, may be on standby for data reception through the other cellular network). The cellular network that is not being used for data communication and the electronic device may be connected on a periodic basis for transmitting or receiving paging messages. For example, when performing data communication through the first cellular network, the communication processor 510 may allocate RF resources (e.g., transceiver, amplifier, and/or low-noise amplifier) included in the communication circuit 520 to the first subscriber identity module 541 (or, first cellular network). The communication processor 510 may perform data communication through the RF resources allocated to the first subscriber identity module 541. In this case, the RF resources are not allocated to the second subscriber identity module 543, and the communication processor 510 may be in a state where it is unable to perform data communication through the second cellular network. The communication processor 510 may allocate RF resources to the second subscriber identity module 543 at specified periodicity. The communication processor 510 may receive data (e.g., paging message) transmitted by the second cellular network while RF resources are allocated to the second subscriber identity module 543. The communication processor 510 may allocate RF resources again to the first subscriber identity module 541 in response to expiration of the specified period and perform data communication through the first cellular network.

The RF chain electrically connected to the first antenna 531 and the RF chain electrically connected to the second antenna 533 may be different RF chains. If the RF chain electrically connected to the first antenna 531 and the RF chain electrically connected to the second antenna 533 are different RF chains, the communication processor 510 may connect to and transmit or receive data to or from the first cellular network and the second cellular network simultaneously (DSDA; dual SIM dual active) by using the first subscriber identity module 541 and the second subscriber identity module 543. According to one example, the communication processor 510 may receive data from the first cellular network or transmit data to the first cellular network via the first antenna 531 and the RF chain electrically connected to the first antenna 531. The communication processor 510 may receive data from the second cellular network or transmit data to the second cellular network through the second antenna 533 and the RF chain electrically connected to the second antenna 533. The mode in which data transmission/reception through the first cellular network and data transmission/reception through the second cellular network are simultaneously performed may be defined as the second mode.

The electronic device 101 may provide the first mode in which one application among the application capable of providing various services through the first cellular network and the application capable of providing various services through the second cellular network is executed. In the first mode, the electronic device 101 may be connected to one of the first cellular network and the second cellular network. The electronic device 101 may provide the second mode in which the application capable of providing various services through the first cellular network and the application capable of providing various services through the second cellular network are executed simultaneously. In the second mode, the electronic device 101 may be connected to both the first cellular network and the second cellular network. In the following description, a description will be given of embodiments in which the electronic device 101 is in the second mode.

The application processor 550 may install a first application, which is an application capable of providing various services through the first cellular network, in a first region (not shown) of the memory (e.g., memory 130 in FIG. 1), and may install a second application, which is an application capable of providing various services through the second cellular network, in a second region (not shown) of the memory 130. The first region and the second region are distinct regions, and the size of the first region and the size of the second region may be set in various ways (e.g., settings of the user of the electronic device 101). The first application may transmit or receive data over an Internet packet data network (IPDN) between the first cellular network and the electronic device 101, and the second application may transmit or receive data over the IPDN between the second cellular network and the electronic device 101.

Some of the applications installed in the first region may be the same applications as some of the applications installed in the second region. The IP (internet protocol) addresses assigned to some of the applications installed in the first region may be different from the IP addresses assigned to some of the applications installed in the second region because the IPDN used by some of the applications installed in the first region may be different from the IPDN used by some of the applications installed in the second region. Hence, an IP address-based application installed in the first region, and an application installed in the second region and identical to the IP address-based application installed in the first region may be executed simultaneously.

The application processor 550 may detect the execution of the first application or the IPDN setup request from the first application, and request the communication processor 510 to set up the IPDN between the first cellular network and the electronic device 101. The communication processor 510 may, as part of the setup operation of the IPDN between the first cellular network and the electronic device 101, configure the RF chain electrically connected to the first antenna 531 to process signals of the frequency band of the first cellular network. The communication processor 510 may receive data from the first cellular network or transmit data to the first cellular network through the first antenna 531 and the RF chain electrically connected to the first antenna 531.

The application processor 550 may detect the execution of the second application or the IPDN setup request from the second application, and request the communication processor 510 to set up the IPDN between the second cellular network and the electronic device 101. The communication processor 510 may, as part of the setup operation of the IPDN between the second cellular network and the electronic device 101, configure the RF chain electrically connected to the second antenna 533 to process signals of the frequency band of the second cellular network. The communication processor 510 may receive data from the second cellular network or transmit data to the second cellular network through the second antenna 533 and the RF chain electrically connected to the second antenna 533.

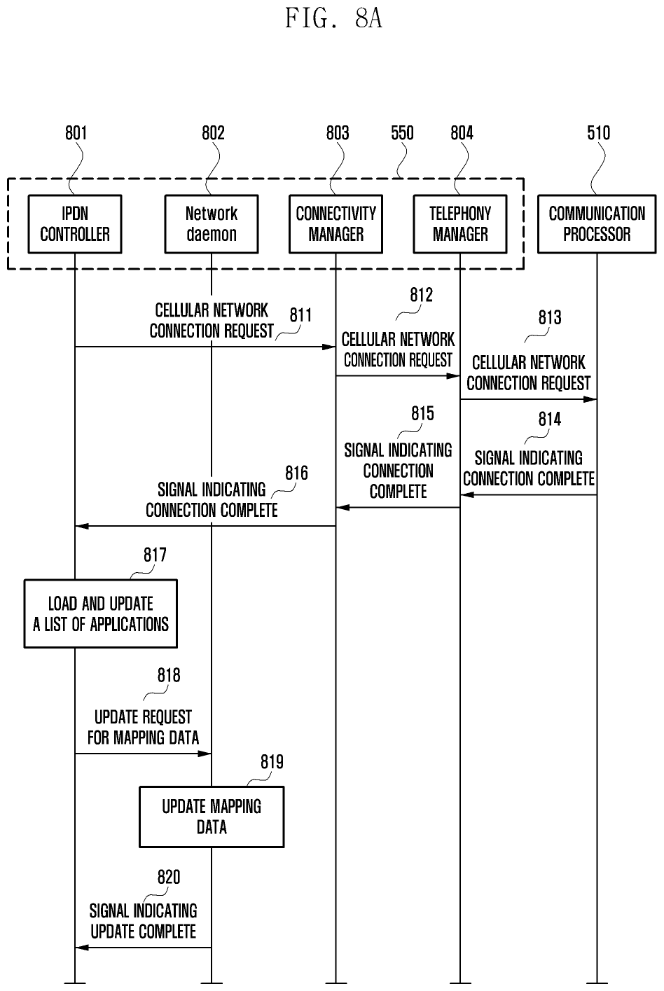

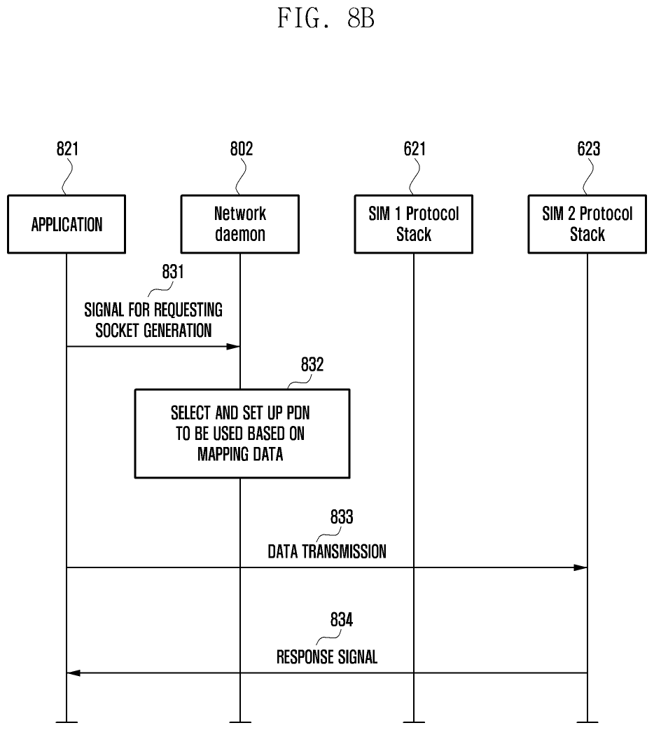

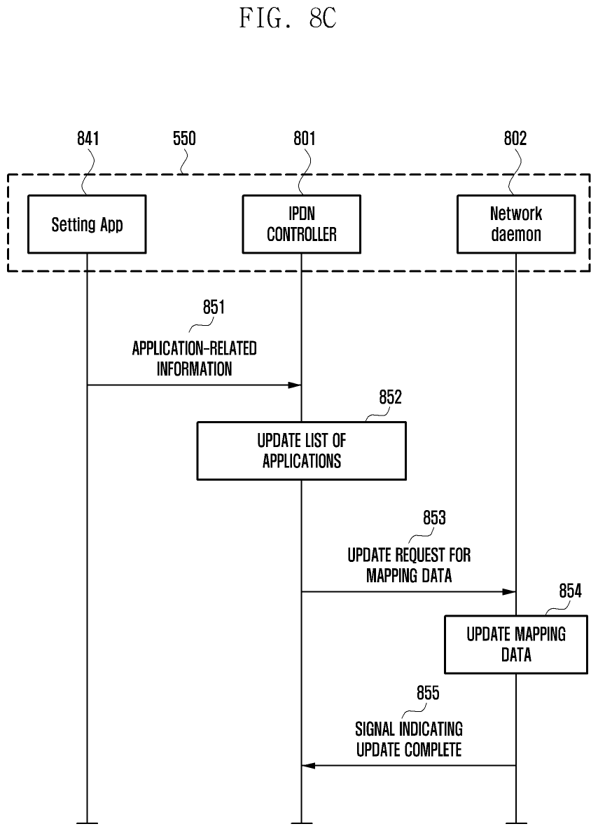

The application processor 550 may store mapping data in which the identification information of an application and the identification information of a cellular network to be used by the application are mapped on the memory 130. The application processor 550 may identify the identification information of an application having requested transmission of data, and may identify the cellular network corresponding to the identification information of the application with reference to the mapping data. The application processor 550 may transfer a signal for requesting activation of the connection to the identified cellular network to the communication processor 510. The communication processor 510 may transmit data to the identified cellular network. The mapping data may be changed (updated or created) as applications are installed, modified, and/or deleted. Updating the mapping data is described in FIG. 8C.

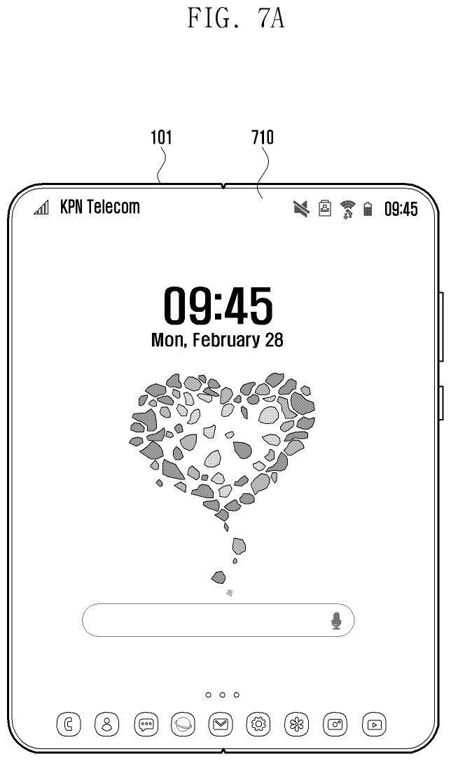

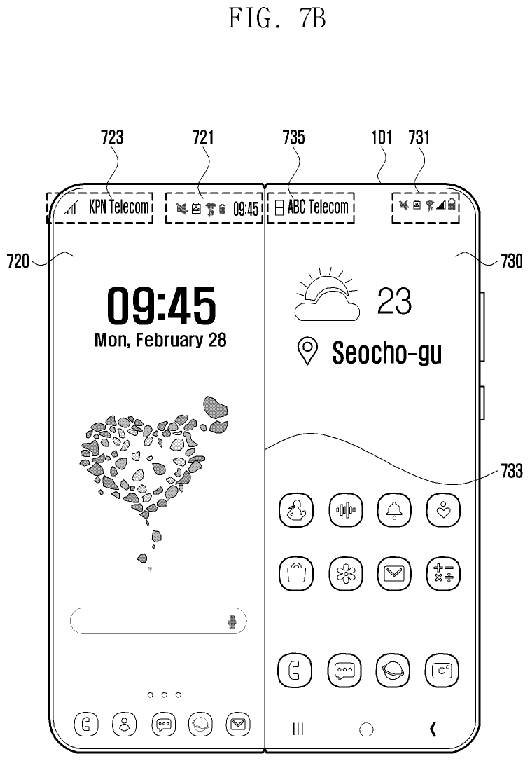

The application processor 550 may execute the first application and the second application simultaneously. When executing the first application and the second application simultaneously, the application processor 550 may display the execution screen of the first application and the execution screen of the second application on the display (e.g., display module 160 in FIG. 1). The application processor 550 may support a split screen mode in which the execution screen of the first application is displayed on a portion of the display module 160 and the execution screen of the second application is displayed on another portion of the display module 160. The split screen mode will be described later in FIGS. 7A and 7B.

The communication processor 510 may perform a series of operations to transmit/receive data through the first cellular network and/or transmit/receive data through the second cellular network simultaneously.

The communication circuit 520 may perform the data transmission/reception operation over the first cellular network and the data transmission/reception operation over the second cellular network simultaneously by use of a combination of specific frequency bands due to various causes (e.g., interference between the signal transmitted or received through the first antenna 531 and the signal transmitted or received through the second antenna 533). For example, the communication circuit 520 may be implemented to enable transmission and/or reception of signals of a first frequency band and a second frequency band simultaneously, but may be unable to perform transmission and/or reception of signals of the first frequency band and a third frequency band simultaneously. Hence, the communication processor 510 may connect to the first cellular network and/or the second cellular network by using a frequency band that enables the communication circuit 510 to support transmission/reception of signals of different frequency bands at the same time.

The communication processor 510 may store, on the memory 130, information related to the communication circuit 520 including a combination of frequency bands through which the communication circuit 520 can transmit and/or receive signals of different frequency bands simultaneously. The communication processor 510 may determine the frequency bands for connection setup based on the measurement object (or, system information block (SIB)) received from the first cellular network, the measurement object (or, system information) received from the second cellular network, and/or information related to the communication circuit 520.

For example, the communication circuit 520 may support transmission of a signal of a first frequency band and transmission of a signal of a second frequency band simultaneously, the measurement object (or, system information) received from the first cellular network may include information indicating that there is a node supporting the first frequency band, and the measurement object (or, system information) received from the second cellular network may include information indicating that there is a node supporting the second frequency band. Based on the measurement object (or, system information) received from the first cellular network, the measurement object (or, system information) received from the second cellular network, and/or the information related to the communication circuit 520, the communication processor 510 may determine whether there is a combination of connectable frequency bands (e.g., first frequency band and second frequency band) among combinations of frequency bands (e.g., first frequency band and second frequency band) that allow data transmission through the first cellular network and data transmission through the second cellular network to be performed simultaneously. Based on determining that there is a combination of connectable frequency bands (e.g., first frequency band and second frequency band), the communication processor 510 may control the communication circuit 520 to activate (or maintain) the connection to the first cellular network through the first frequency band and to activate the connection to the second cellular network through the second frequency band. If being connected to the first cellular network through a frequency band other than the first frequency band, the communication processor 510 may control the communication circuit 520 to connect to the first cellular network through the first frequency band. Alternatively, the communication processor 510 may switch to the standalone mode when connected to the first cellular network in the non-standalone mode. In the second mode, the communication processor 510 may transmit or receive data to or from the first cellular network through the first frequency band, and may transmit or receive data to or from the second cellular network through the second frequency band.

For another example, the communication circuit 520 may support transmission of a signal of a first frequency band and transmission of a signal of a third frequency band simultaneously, the measurement object (or, system information) received from the first cellular network may include information indicating that there is a node supporting the first frequency band, and the measurement object (or, system information) received from the second cellular network may include information indicating that there is a node supporting the second frequency band. Based on the measurement object (or, system information) received from the first cellular network, the measurement object (or, system information) received from the second cellular network, and/or the information related to the communication circuit 520, the communication processor 510 may determine that there is no combination of connectable frequency bands among combinations of frequency bands (e.g., first frequency band and third frequency band) that allow data transmission through the first cellular network and data transmission through the second cellular network to be performed simultaneously. The communication processor 510 may not establish a connection to the second cellular network while maintaining the connection to the first cellular network. The communication processor 510 may stand by until the connection to the first cellular network is released, and then establish a connection to the second cellular network. Alternatively, the communication processor 510 may release the connection to the first cellular network and activate the connection to the second cellular network.

The communication processor 510 may determine frequency bands for connection setup based on the priorities of communication schemes of the first cellular network and the second cellular network (e.g., standalone mode of fifth generation cellular communication, fourth generation cellular communication, third generation cellular communication, and second generation cellular communication). The communication processor 510 may identify a frequency band that is connectable through a communication scheme with a high priority (e.g., fifth generation cellular communication being a more recent generation of cellular communication). For example, the communication processor 510 may find a combination of frequency bands that are simultaneously connectable through fifth generation cellular communication for the first cellular network and fifth generation cellular communication for the second cellular network. If failing to find a combination of frequency bands that are simultaneously connectable through fifth generation cellular communication for the first cellular network and fifth generation cellular communication for the second cellular network, the communication processor 510 may find a combination of frequency bands that are simultaneously connectable through fifth generation cellular communication for the first cellular network and fourth generation cellular communication for the second cellular network. If failing to find a combination of frequency bands that are simultaneously connectable through fifth generation cellular communication for the first cellular network and fourth generation cellular communication for the second cellular network, the communication processor 510 may find a combination of frequency bands that are simultaneously connectable through fourth generation cellular communication for the first cellular network and fourth generation cellular communication for the second cellular network. In this way, the communication processor 510 may determine whether there is a combination of connectable frequency bands among combinations of frequency bands that allow data transmission through the first cellular network and data transmission through the second cellular network to be performed simultaneously (e.g., first frequency band and third frequency band).

If there is no combination of connectable frequency bands among combinations of frequency bands that allow data transmission through the first cellular network and data transmission through the second cellular network to be performed simultaneously, the communication processor 510 may select a cellular network not to be connected (or, to be released) among the first cellular network and the second cellular network.

When selecting a cellular network not to be connected (or, to be released), the communication processor 510 may consider the priority of an application (or service) that will use the cellular network. The communication processor 510 may select a cellular network not to be connected (or, to be released) based on the priority of the application (or, service) that will use the cellular network.

The priority of an application (or, service) may be determined in various ways.

The priority of an application (or, service) may be set by the manufacturer of the application, or may be set (or, changed) according to the user's settings. For example, some applications (e.g., business applications) among applications pre-installed by the manufacturer of the electronic device 101 may have a higher priority than other applications.

The priority of an application (or, service) may be determined based on the characteristics of the application. For example, an application (or, service) that requires low latency or high transmission speed may have a higher priority than an application (or, service) that can be implemented with relatively high latency or low transmission speed. For another example, an application (or, service) that provides a real-time service (e.g., application installed on a vehicle in relation to autonomous driving) may have a higher priority than an application (or, service) that provides a non-real time service (e.g., application that reports the status of a vehicle). As another example, an application (or, service) that provides an emergency service (e.g., application related to 211 or 911 emergency) may have a higher priority than an application that provides a non-emergency service.

The communication processor 510 may activate (or, maintain) the connection to a cellular network to be used by an application with a relatively high priority. Alternatively, the communication processor 510 may deactivate (or, not make a connection to) a cellular network to be used by an application with a relatively low priority.

According to an example, the application processor 550 may execute a first application that provides a service via the first cellular network while being connected to the first cellular network. The communication processor 510 may receive a request for activating the connection to the second cellular network from the application processor 550 according to execution of a second application having a higher priority than the first application.

Upon receiving a request for activating the connection to the second cellular network, the communication processor 510 may determine whether there is a combination of connectable frequency bands among combinations of frequency bands that allow data transmission through the first cellular network and data transmission through the second cellular network to be performed simultaneously. Alternatively, before receiving a request for activating the connection to the second cellular network while being connected to the first cellular network, the communication processor 510 may determine in advance whether there is a combination of connectable frequency bands among combinations of frequency bands that allow data transmission through the first cellular network and data transmission through the second cellular network to be performed simultaneously.

Based on the measurement object (or, system information) received from the first cellular network, the measurement object (or, system information) received from the second cellular network, and/or the information related to the communication circuit 520, the communication processor 510 may determine that there is no combination of connectable frequency bands among combinations of frequency bands that allow data transmission through the first cellular network and data transmission through the second cellular network to be performed simultaneously.

Upon determining that there is no combination of connectable frequency bands among combinations of frequency bands that allow data transmission through the first cellular network and data transmission through the second cellular network to be performed simultaneously, the communication processor 510 may release the connection to the first cellular network used by the first application with a relatively low priority and activate the connection to the second cellular network used by the second application with a relatively high priority. Releasing the connection to the first cellular network may include deactivating the IPDN between the first cellular network and the electronic device 101. Activating the connection to the second cellular network may include activating the IPDN between the second cellular network and the electronic device 101.

The communication processor 510 may receive data over the second cellular network and transfer the received data to the application processor 550 through the IPDN between the second cellular network and the electronic device 101. The application processor 550 may carry out the service provided by the second application based on the data received through the IPDN between the second cellular network and the electronic device 101.

The communication processor 510 may transmit data to the second cellular network through the IPDN between the second cellular network and the electronic device 101.

As the execution of the second application ends, the communication processor 510 may deactivate the connection to the second cellular network and reactivate the connection to the first cellular network. The communication processor 510 may receive data over the first cellular network and transfer the received data to the application processor 550 through the IPDN between the first cellular network and the electronic device 101. The application processor 550 may carry out the service provided by the first application based on the data received through the IPDN between the first cellular network and the electronic device 101.

Based on determining that there is a combination of connectable frequency bands (e.g., first frequency band and second frequency band) among combinations of frequency bands that allow data transmission through the first cellular network and data transmission through the second cellular network to be performed simultaneously, the communication processor 510 may control the communication circuit 520 to activate (or, maintain) the connection to the first cellular network via the first frequency band and to activate the connection to the second cellular network via the second frequency band.

The communication processor 510 may transmit and/or receive data related to the first application to or from the first cellular network through the first frequency band, and may transmit and/or receive data related to the second application to or from the second cellular network through the second frequency band.

When connected to the first cellular network through a frequency band other than the first frequency band, the communication processor 510 may control the communication circuit 520 to make a connection to the first cellular network through the first frequency band. The communication processor 510 may control the communication circuit 520 to release the connection to the first cellular network through the different frequency band and to make a connection to the first cellular network through the first frequency band.

When connected to the first cellular network in the non-standalone mode, the communication processor 510 may switch to the standalone mode. Data transmission is performed to the first cellular network via the first antenna 531 and the second antenna 533 in the non-standalone mode, so the communication processor 510 may enable data transmission to the second cellular network by switching from the non-standalone mode to the standalone mode.

While connected to the first cellular network, the communication processor 510 may execute a first application that carries out a service through the first cellular network. The communication processor 510 may receive a request for activating the connection to the second cellular network from the application processor 550 according to execution of a third application having a lower priority than the first application. The third application is an application installed in the second region of the memory 130, and may be an application installed in the same region as the second application.

Upon receiving a request for activating the connection to the second cellular network, the communication processor 510 may determine whether there is a combination of connectable frequency bands among combinations of frequency bands that allow data transmission through the first cellular network and data transmission through the second cellular network to be performed simultaneously. Alternatively, before receiving a request for activating the connection to the second cellular network while being connected to the first cellular network, the communication processor 510 may determine in advance whether there is a combination of connectable frequency bands among combinations of frequency bands that allow data transmission through the first cellular network and data transmission through the second cellular network to be performed simultaneously.

Based on the measurement object (or, system information) received from the first cellular network, the measurement object (or, system information) received from the second cellular network, and/or the information related to the communication circuit 520, the communication processor 510 may determine that there is no combination of connectable frequency bands among combinations of frequency bands that allow data transmission through the first cellular network and data transmission through the second cellular network to be performed simultaneously.

Based on determining that there is no combination of connectable frequency bands among combinations of frequency bands that allow data transmission through the first cellular network and data transmission through the second cellular network to be performed simultaneously, the communication processor 510 may maintain the connection to the first cellular network used by the first application with a relatively high priority and not set up a connection to the second cellular network used by the second application with a relatively high priority.

The communication processor 510 may transfer information indicating that making a connection to the second cellular network is not possible to the application processor 550. The application processor 550 may output the information indicating that making a connection to the second cellular network is not possible on the execution screen of the second application.

As the execution of the first application ends, the communication processor 510 may deactivate the connection to the first cellular network and activate the connection to the second cellular network. The communication processor 510 may receive data through the second cellular network and transfer the received data to the application processor 550 through the IPDN between the second cellular network and the electronic device 101. The application processor 550 may carry out the service provided by the second application based on the data received through the IPDN between the second cellular network and the electronic device 101.

Based on determining that there is a combination of connectable frequency bands (e.g., first frequency band and second frequency band) among combinations of frequency bands that allow data transmission through the first cellular network and data transmission through the second cellular network to be performed simultaneously, the communication processor 510 may control the communication circuit 520 to activate (or, maintain) the connection to the first cellular network via the first frequency band and to activate the connection to the second cellular network via the second frequency band.

The communication processor 510 may transmit and/or receive data related to the first application to or from the first cellular network via the first frequency band, and may transmit and/or receive data related to the second application to or from the second cellular network via the second frequency band.

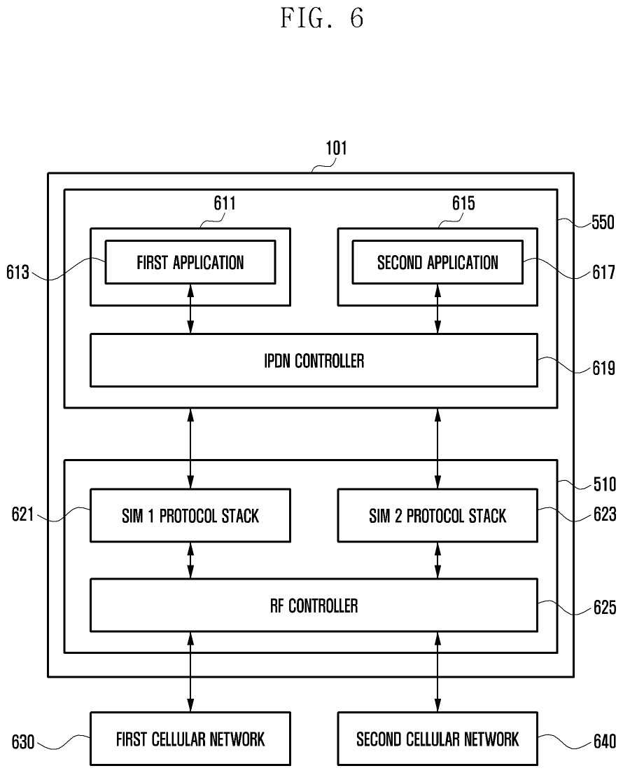

FIG. 6 is a diagram illustrating a hierarchical structure for performing data transmission through a first cellular network and data transmission through a second cellular network simultaneously in an electronic device according to an embodiment of the disclosure.

Referring to FIG. 6, the application processor (e.g., application processor 550 in FIG. 5) of the electronic device (e.g., electronic device 101 in FIG. 1) may provide the second mode in which a first application 613 capable of providing various services through the first cellular network 630 and a second application 617 capable of providing various services through the second cellular network 640 are simultaneously executed.

The application processor 550 may install the first application, which is an application capable of providing various services through the first cellular network 630, in the first region 611, and may install the second application, which is an application capable of providing various services through the second cellular network 640, in the second region 615.

The first region 611 and the second region 615 may be distinct regions. The first region 611 may be a region where applications that can carry out services through the first cellular network 630 may be installed, and the second region 615 may be a region where applications that can carry out services through the second cellular network 640 may be installed. The sizes of the first region 611 and the second region 615 may be variable and may be changed in various ways (e.g., according to the settings of the user of the electronic device 101).

The IPDN controller 619 is an entity implemented on the application processor 550 or the operating system OS of the application processor 550, and may select an Internet protocol data network (IPDN) to be used by an application among multiple IPDNs. The IPDN controller 619 may detect that the electronic device 101 is running in the second mode where an application capable of providing various services through the first cellular network 630 and an application capable of providing various services through the second cellular network 640 are simultaneously executed, and may perform a series of operations to activate a first IPDN located between the first cellular network 630 and the electronic device 101 and a second IPDN located between the second cellular network 640 and the electronic device 101.

The IPDN controller 619 may detect execution of the first application and activate the interface between the first IPDN to be used by the first application and the SIM 1 protocol stack 621 corresponding to the first cellular network. The SIM 1 protocol stack 621 may be an entity that includes entities (e.g., PDCP, MAC, RLC) supporting various protocols implemented on the wireless communication supported by the first cellular network 630.

The IPDN controller 619 may detect execution of the second application and activate the interface between the second IPDN to be used by the second application and the SIM 2 protocol stack 623 corresponding to the second cellular network. The SIM 2 protocol stack 623 may be an entity that includes entities (e.g., PDCP, MAC, RLC) supporting various protocols implemented on the wireless communication supported by the second cellular network 640.

The IPDN controller 619 may forward data received through the first IPDN and/or the second IPDN to the first application 613 and/or the second application 617. The IPDN controller 619 may select an application to which the data to be received will be forwarded with reference to the mapping data in which information included in the data received through the first IPDN and/or the second IPDN, identification information of an application, and identification information of the cellular network to be used by the application are mapped. The IPDN controller 619 may identify the cellular network (e.g., the first cellular network) having transmitted the data based on the information included in the data, and may forward the data to the first application 613 corresponding to the identified cellular network with reference to the mapping data.

The IPDN controller 619 may receive data to be transmitted to the outside by the first application 613 and/or the second application 617, and may select one of the first IPDN and/or the second IPDN based on the mapping data. The IPDN controller 619 may select an IPDN to which data is to be forwarded with reference to the identification information of the application having transmitted the data and the mapping data in which the identification information of the application and the identification information of the cellular network to be used by the application are mapped. The IPDN controller 619 may identify the application having transmitted the data (e.g., first application) based on information included in the data, and may transmit the data to the first cellular network 630 through the first IPDN corresponding to the identified application with reference to the mapping data.

Referring to FIG. 6, the communication processor (e.g., communication processor 510 in FIG. 5) may include a SIM 1 protocol stack 621, a SIM 2 protocol stack 623, and/or an RF controller 625.

The SIM 1 protocol stack 621 may be an entity that includes entities (e.g., PDCP, MAC, RLC) supporting various protocols implemented on the wireless communication supported by the first cellular network 630.

The SIM 2 protocol stack 623 may be an entity that includes entities (e.g., PDCP, MAC, RLC) supporting various protocols implemented on the wireless communication supported by the second cellular network 640.

When the electronic device 101 operates in the second mode, the RF controller 625 may determine a frequency band for connecting to the first cellular network 630 and a frequency band for connecting to the second cellular network 640. The RF controller 625 may determine a combination of frequency bands that allows the communication circuit 510 to transmit and/or receive different frequency band signals simultaneously, and may connect to the first cellular network and/or the second cellular network.

The RF controller 625 may determine a combination of connectable frequency bands with reference to the information related to the communication circuit 520 stored in the memory 130 that includes combinations of frequency bands that allow the communication circuit 520 to transmit and/or receive different frequency band signals simultaneously.

The RF controller 625 may determine frequency bands for connection setup based on the measurement object (or, system information block (SIB)) received from the first cellular network 630, the measurement object (or, system information) received from the second cellular network 640, and/or the information related to the communication circuit 520.

For example, the communication circuit 520 may support transmission of a signal of a first frequency band and transmission of a signal of a second frequency band simultaneously, the measurement object (or, system information) received from the first cellular network 630 may include information indicating that there is a node supporting the first frequency band, and the measurement object (or, system information) received from the second cellular network 640 may include information indicating that there is a node supporting the second frequency band. Based on the measurement object (or, system information) received from the first cellular network, the measurement object (or, system information) received from the second cellular network, and/or the information related to the communication circuit 520, the RF controller 625 may determine that there is a combination of connectable frequency bands (e.g., first frequency band and second frequency band) among combinations of frequency bands (e.g., first frequency band and second frequency band) that allow data transmission through the first cellular network and data transmission through the second cellular network to be performed simultaneously. Based on the presence of a combination of connectable frequency bands (e.g., first frequency band and second frequency band), the RF controller 625 may control the communication circuit 520 to activate (or maintain) the connection to the first cellular network through the first frequency band and to activate the connection to the second cellular network through the second frequency band.

If being connected to the first cellular network through a frequency band other than the first frequency band, the RF controller 625 may control the communication circuit 520 to connect to the first cellular network through the first frequency band.

Alternatively, the RF controller 625 may switch to the standalone mode when connected to the first cellular network in the non-standalone mode.

For another example, the communication circuit 520 may support transmission of a signal of a first frequency band and transmission of a signal of a third frequency band simultaneously, the measurement object (or, system information) received from the first cellular network may include information indicating that there is a node supporting the first frequency band, and the measurement object (or, system information) received from the second cellular network may include information indicating that there is a node supporting the second frequency band.

Based on the measurement object (or, system information) received from the first cellular network, the measurement object (or, system information) received from the second cellular network, and/or the information related to the communication circuit 520, the RF controller 625 may determine that there is no combination of connectable frequency bands among combinations of frequency bands (e.g., first frequency band and third frequency band) that allow data transmission through the first cellular network and data transmission through the second cellular network to be performed simultaneously. The RF controller 625 may not establish a connection to the second cellular network while maintaining the connection to the first cellular network.

The RF controller 625 may stand by until the connection to the first cellular network is released, and then establish a connection to the second cellular network. Alternatively, the RF controller 625 may release the connection to the first cellular network and activate the connection to the second cellular network.

The RF controller 625 may determine frequency bands for connection setup based on the priorities of communication schemes of the first cellular network and the second cellular network (e.g., standalone mode of fifth generation cellular communication, fourth generation cellular communication, third generation cellular communication, and second generation cellular communication). The RF controller 625 may identify a frequency band that is connectable through a communication scheme with a high priority (e.g., fifth generation cellular communication being a more recent generation of cellular communication). For example, the RF controller 625 may find a combination of frequency bands that are simultaneously connectable through fifth generation cellular communication for the first cellular network and fifth generation cellular communication for the second cellular network. If failing to find a combination of frequency bands that are simultaneously connectable through fifth generation cellular communication for the first cellular network and fifth generation cellular communication for the second cellular network, the RF controller 625 may find a combination of frequency bands that are simultaneously connectable through fifth generation cellular communication for the first cellular network and fourth generation cellular communication for the second cellular network. If failing to find a combination of frequency bands that are simultaneously connectable through fifth generation cellular communication for the first cellular network and fourth generation cellular communication for the second cellular network, the RF controller 625 may find a combination of frequency bands that are simultaneously connectable through fourth generation cellular communication for the first cellular network and fourth generation cellular communication for the second cellular network. In this way, the RF controller 625 may determine whether there is a combination of connectable frequency bands among combinations of frequency bands that allow data transmission through the first cellular network and data transmission through the second cellular network to be performed simultaneously (e.g., first frequency band and third frequency band).

FIG. 7A is a diagram illustrating an embodiment in which an electronic device operates in a first mode according to an embodiment of the disclosure.

Referring to FIG. 7A, the electronic device (e.g., electronic device 101 in FIG. 1) may provide the first mode in which one of an application capable of providing various services through the first cellular network and an application capable of providing various services through the second cellular network is executed.

The first mode may be a mode in which the connection is made to one of the first cellular network and the second cellular network. When the electronic device 101 is in the first mode, the electronic device 101 may perform data communication through one network and may not perform data communication through the other cellular network (or, may stand by for data reception through the other cellular network). The cellular network that is not being used for data communication and the electronic device may be connected on a periodic basis for transmitting or receiving a paging message.

For example, when performing data communication through the first cellular network, the electronic device 101 may allocate RF resources (e.g., transceiver, amplifier, and/or low-noise amplifier) included in the communication circuit (e.g., communication circuit 520 in FIG. 5) to the first subscriber identity module (e.g., first subscriber identity module 541 in FIG. 1) (or, first cellular network). The electronic device 101 may perform data communication through the RF resources allocated to the first subscriber identity module 541. In this case, the RF resources are not allocated to the second subscriber identity module (e.g., second subscriber identity module 543 in FIG. 5), and the electronic device 101 may be in a state where it is unable to perform data communication through the second cellular network. However, the electronic device 101 may allocate RF resources to the second subscriber identity module 543 at specified periodicity. The electronic device 101 may receive data (e.g., paging message) transmitted by the second cellular network while RF resources are allocated to the second subscriber identity module 543. The electronic device 101 may allocate RF resources again to the first subscriber identity module 541 in response to expiration of the specified period and perform data communication through the first cellular network.

The electronic device 101 may display an execution screen 710 of the first application (e.g., the first application 613 in FIG. 6) capable of providing a service via the first cellular network on the display (e.g., the display module 160 in FIG. 1).

FIG. 7B is a diagram illustrating an embodiment in which an electronic device operates in a second mode according to an embodiment of the disclosure.

Referring to FIG. 7B, the electronic device (e.g., electronic device 101 in FIG. 1) may provide the second mode in which both an application capable of providing various services via the first cellular network and an application capable of providing various services via the second cellular network can be executed.

The electronic device 101 may be in a state of being connected to both the first cellular network and the second cellular network in the second mode.

The electronic device 101 may install a first application (e.g., first application 613 in FIG. 6), which is an application capable of providing various services through the first cellular network, in a first region (e.g., first region 611 of FIG. 6) of the memory (e.g., memory 130 in FIG. 1), and may install a second application (e.g., second application 617 in FIG. 6), which is an application capable of providing various services through the second cellular network, in a second region (e.g., second region 615 in FIG. 6) of the memory 130. The first region and the second region are distinct regions, and the size of the first region and the size of the second region may be set in various ways (e.g., settings of the user of the electronic device 101). The first application 613 may transmit or receive data through an Internet packet data network (IPDN) between the first cellular network and the electronic device 101, and the second application 617 may transmit or receive data through an IPDN between the second cellular network and the electronic device 101.

The electronic device 101 may execute the first application 613 and the second application 617 simultaneously. When the first application 613 and the second application 617 are being executed simultaneously, the application processor 550 may display an execution screen 720 of the first application 613 and an execution screen 730 of the second application 617 on the display (e.g., the display module 160 in FIG. 1). The electronic device 101 may support a split screen mode in which the execution screen 720 of the first application 613 is displayed on a portion of the display module 160 and the execution screen 730 of the second application 617 is displayed on another portion of the display module 160.

The execution screen 720 of the first application 613 may include information 723 related to the cellular network (e.g., first cellular network) used by the first application 613 and information 721 related to the status of the electronic device 101 (e.g., remaining battery capacity, current time).

The execution screen 730 of the second application 617 may include information 735 related to the cellular network (e.g., second cellular network) used by the second application 617 and information 731 related to the status of the electronic device 101. The information 731 related to the status of the electronic device 101 may be at least partially identical to the information related to the status of the electronic device 101 included in the execution screen 720 of the first application 611.

The electronic device 101 may change the sizes of the execution screen 720 of the first application 613 and the execution screen 730 of the second application 617 in various ways. The electronic device 101 may change the sizes of the execution screen 720 of the first application 613 and the execution screen 730 of the second application 617 in response to a user input on the boundary line 733 between the execution screen 720 of the first application 613 and the execution screen 730 of the second application 617.

Alternatively, the electronic device 101 may provide an entire screen mode in which either the execution screen 720 of the first application 613 or the execution screen 730 of the second application 617 is displayed. The electronic device 101 may provide a user interface for switching between the split screen mode and the entire screen mode.

According to an example, the electronic device 101 may switch from the entire screen mode to the split screen mode in response to receiving a user input (e.g., pinch to zoom in).

According to an example, the electronic device 101 may switch from the split screen mode to the entire screen mode in response to receiving a user input (e.g., pinch to zoom out).

According to an example, the electronic device 101 may switch from the split screen mode to the entire screen mode in response to a user input on the boundary line 733 (e.g., user input for moving the boundary in one direction) between the execution screen 720 of the first application 613 and the execution screen 730 of the second application 617.

According to an example, the electronic device 101 may provide a graphical button or a physical button for switching from the split screen mode to the entire screen mode (or, from the entire screen mode to the split screen mode).

FIG. 8A is a diagram illustrating an embodiment in which an electronic device performs a series of operations to remain in a second mode upon booting of an electronic device according to an embodiment of the disclosure.

Referring to FIG. 8A, the application processor (e.g., application processor 550 in FIG. 5) of the electronic device (e.g., electronic device 101 in FIG. 1) may include an IPDN controller 801 (e.g., IPDN controller 619 in FIG. 6), a network daemon 802 that performs a function corresponding to a processing request, a connectivity manager 803 that manages the connection between the electronic device 101 and a cellular network, and/or a telephony manager 804 that manages the telephony function of a cellular network. The IPDN controller 801, network daemon 802, connectivity manager 803 and/or telephony manager 804 are entities implemented in software or hardware on the application processor 550, and may also be implemented on the framework layer of the application processor 550.

The embodiment shown in FIG. 8A illustrates an embodiment in which a connection is made to the first cellular network and/or the second cellular network as booting of the electronic device 101 is completed.

At operation 811, the IPDN controller 801 may make a cellular network connection request (e.g., requestNetwork). Making a cellular network connection request may correspond to transmitting a signal for making a cellular network connection request to the connectivity manager 803. For convenience of explanation, it is assumed that the IPDN controller 801 makes a connection request as to the second cellular network. Making a connection to the second cellular network may include activating an IPDN between the second cellular network and the electronic device 101.

At operation 812, the connectivity manager 803 may make a cellular network connection request. Making a cellular network connection request may correspond to transmitting a signal for making a cellular network connection request to the telephony manager 804.

At operation 813, the telephony manager 804 may make a cellular network connection request. Making a cellular network connection request may correspond to transmitting a signal for making a cellular network connection request to the communication processor 510.

In response to the cellular network connection request, the communication processor 510 may activate the IPDN between the second cellular network and the electronic device 101.

At operation 814, the communication processor 510 may transmit the telephony manager 804 a signal indicating that the connection to the cellular network is complete.

At operation 815, the telephony manager 804 may transmit the connectivity manager 803 the signal indicating that the connection to the cellular network is complete.

At operation 816, the connectivity manager 803 may transmit the IPDN controller 801 the signal indicating that the connection to the cellular network is complete (e.g., onAvailableNetwork).

At operation 817, the IPDN controller 801 may load and/or update a list of applications.

The list of applications may include a list of identification information of applications installed in the second region (e.g., second region 615 in FIG. 6). The list of applications may include a list of identification information of applications that transmit or receive data over the second cellular network.

The IPDN controller 801 may update the list of applications when an application is installed in the second region 615 or an application installed therein is changed or deleted. For example, when an application is newly installed in the second region 615, the IPDN controller 801 may add identification information of the added application to the list of applications; when an application installed in the second region 615 is deleted, the IPDN controller 801 may remove identification information of the deleted application from the list of applications.

At operation 818, the IPDN controller 801 may make an update request for the mapping data.

The mapping data may indicate data in which the identification information of an application and the identification information of a cellular network to be used by the application are mapped. The network daemon 802 may identify identification information of an application having requested data transmission based on the mapping data, and may identify the cellular network corresponding to the identification information of the application with reference to the mapping data.

Making an update request for the mapping data may include transmitting a list of applications to the network daemon 802, and/or transmitting a signal requesting an update of the mapping data (e.g., networkAddUidRangesParcel) to the network daemon 802.

At operation 819, the network daemon 802 may update the mapping data (e.g., addUsersToNetwork) based on the application list.

At operation 820, the network daemon 802 may transmit the IPDN controller 801 a signal indicating that the update of the mapping data is complete.

FIG. 8B is a diagram illustrating an embodiment in which an electronic device selects one of a first cellular network or a second cellular network in a second mode and transmits data through a selected cellular network according to an embodiment of the disclosure.

Referring to FIG. 8B, the application processor (e.g., application processor 550 in FIG. 5) of the electronic device (e.g., electronic device 101 in FIG. 1) may include an application 801 (e.g., first application 613, second application 617 in FIG. 6), an IPDN controller 801 (e.g., IPDN controller 619 in FIG. 6), a network daemon 802 that performs a function corresponding to a processing request, a connectivity manager 803 that manages the connection between the electronic device 101 and a cellular network, and/or a telephony manager 804 that manages the telephony function of a cellular network. The IPDN controller 801, network daemon 802, connectivity manager 803 and/or telephony manager 804 are entities implemented in software or hardware on the application processor 550, and may also be implemented on the framework layer of the application processor 550.

The communication processor (e.g., communication processor 510 in FIG. 5) of the electronic device 101 may include a SIM 1 protocol stack (e.g., SIM 1 protocol stack 621 in FIG. 6) and/or a SIM 2 protocol stack (e.g., SIM 2 protocol stack 623 in FIG. 6). The SIM 1 protocol stack 621 may be an entity that includes entities (e.g., PDCP, MAC, RLC) supporting various protocols implemented on the wireless communication supported by the first cellular network. The SIM 2 protocol stack may be an entity that includes entities (e.g., PDCP, MAC, RLC) supporting various protocols implemented on the wireless communication supported by the second cellular network 640.

At operation 831, for transmission and/or reception of data, the application 821 may transmit the network daemon 802 a signal for requesting generation of a socket associated with data.

The socket associated with data may include identification information of the application that will transmit the data.

At operation 832, the network daemon 802 may select and/or set up an IPDN to be used for data transmission based on the mapping data.

The mapping data may indicate data in which identification information of an application and identification information of the IPDN (or, cellular network) to be used by the application are mapped. The network daemon 802 may identify the application having requested data transmission based on the mapping data, and select an IPDN (or, cellular network) corresponding to the application's identification information with reference to the mapping data. Selection of a cellular network may be performed by using the setockopt function.

Referring to FIG. 8B, for convenience of explanation, it is assumed that the network daemon 802 selects a second IPDN between the second cellular network and the electronic device 101.

At operation 833, the application 821 may transmit data to the SIM 2 protocol stack 623.

The SIM 2 protocol stack 623 may receive the data transmitted by the application 821, process the data in a manner suitable to transmission through the second cellular network, and then transmit the processed data to the second cellular network.

After performing data transmission, at operation 834, the SIM 2 protocol stack 623 may transmit a response signal for data transmission to the application 821.

FIG. 8C is a diagram illustrating an embodiment in which an electronic device updates a table for selecting a cellular network to be used to transmit data according to installation or deletion of an application according to an embodiment of the disclosure.

Referring to FIG. 8C, the application processor (e.g., application processor 550 in FIG. 5) of the electronic device (e.g., electronic device 101 in FIG. 1) may include a setting application 841 that configures settings of an installed application, an IPDN controller 801 (e.g., IPDN controller 619 in FIG. 6), and a network daemon 802 that performs a function corresponding to a processing request. The IPDN controller 801 and the network daemon 802 are entities implemented in software or hardware on the application processor 550, and may also be implemented on the framework layer of the application processor 550.

At operation 851, the setting application 841 may transmit information related to the application to the IPDN controller 801.

The application-related information may include information related to an application installed in the first region (e.g., first region 611 in FIG. 6) and/or the second region (e.g., second region 615 in FIG. 6) of the memory (e.g., memory 130 in FIG. 1). According to an example, the application-related information may include identification information of a new application being newly installed on the first region 611 and/or the second region 615, identification information of a modified application if an application installed in the first region 611 and/or the second region 615 has been modified, and/or identification information of a deleted application if an application installed in the first region 611 and/or the second region 615 has been deleted.

Transmission of the application-related information may be performed using the setPDNpreferreduids function.

At operation 852, the IPDN controller 801 may update the list of applications.

The list of applications may include a list of identification information of applications installed in the second region 615. The list of applications may include a list of identification information of applications that transmit or receive data over the second cellular network.

The list of applications may include a list of identification information of applications installed in the first region 611. The list of applications may include a list of identification information of applications that transmit or receive data over the first cellular network.

The IDPN controller 801 may update the list of applications based on the application-related information.

The IPDN controller 801 may update the list of applications when an application is installed in the second region 615 or an application installed therein is changed or deleted. For example, when an application is newly installed in the second region 615, the IPDN controller 801 may add identification information of the added application to the list of applications; when an application installed in the second region 615 is deleted, the IPDN controller 801 may remove identification information of the deleted application from the list of applications.

At operation 853, the IPDN controller 801 may make an update request for the mapping data.

The mapping data may indicate data in which identification information of an application and identification information of a cellular network to be used by the application are mapped. The network daemon 802 may identify the identification information of an application having requested data transmission based on the mapping data, and may identify the cellular network corresponding to the identification information of the application with reference to the mapping data.

Making an update request for the mapping data may include transmitting the network daemon 802 a request signal for deleting the identification information of a deleted application from the mapping data (e.g., networkRemoveUidRangesParcel).

Making an update request for the mapping data may include transmitting the network daemon 802 a request signal for adding the identification information of a newly installed application to the mapping data (e.g., networkAddUidRangesParcel).

At operation 854, the network daemon 802 may update the mapping data based on the application list.

Updating the mapping data by adding identification information of a newly installed application may be performed using the addUsersFromNetwork function, and updating the mapping data by removing identification information of a deleted application may be performed using the removeUsersFromNetwork function.

At operation 855, the network daemon 802 may transmit the IPDN controller 801 a signal indicating that update of the mapping data is completed.

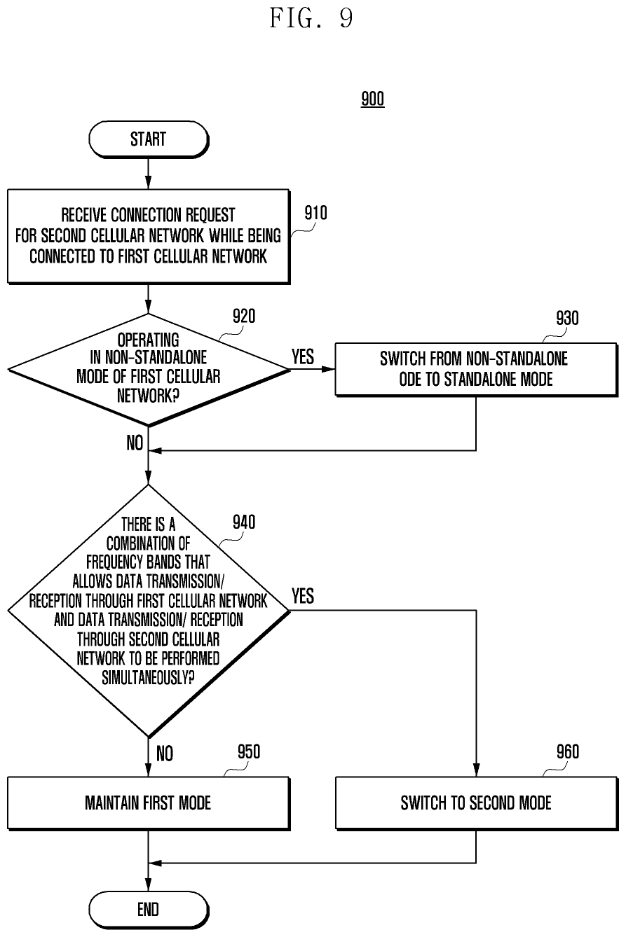

FIG. 9 is a flowchart 900 illustrating operations of an electronic device according to a presence or absence of frequency bands that allow data transmission/reception through a first cellular network and data transmission/reception through a second cellular network to be performed simultaneously according to an embodiment of the disclosure.

Referring to FIG. 9, at operation 910, the electronic device (e.g., electronic device 101 in FIG. 1) may receive a connection request for the second cellular network while being connected to the first cellular network.

The electronic device 101 may be in a state of being connected to the first cellular network and being not connected to the second cellular network, and may operate in the first mode in which one of an application capable of providing various services through the first cellular network and an application capable of providing various services through the second cellular network is executed.

The first mode may be a mode in which the connection is made to one of the first cellular network and the second cellular network. When the electronic device 101 is in the first mode, the electronic device 101 may perform data communication through one network and may not perform data communication through the other cellular network (or, may stand by for data reception through the other cellular network). The cellular network that is not being used for data communication and the electronic device may be connected on a periodic basis for transmitting or receiving a paging message.

At operation 920, the electronic device 101 may determine whether the first cellular network operates in the non-standalone mode.

Upon determining that it is operating in the non-standalone mode of the first cellular network (operation 920—Yes), at operation 930, the electronic device 101 may switch from the non-standalone mode to the standalone mode.

When connected to the first cellular network in the non-standalone mode, the electronic device 101 may switch to the standalone mode. In the non-standalone mode, data transmission is performed to the first cellular network through the first antenna 531 and the second antenna 533, so the communication processor 510 may allow data transmission to be performed to the second cellular network by switching from the non-standalone mode to the standalone mode.

Upon determining that it is not operating in the non-standalone mode of the first cellular network (operation 920—No), at operation 940, the electronic device 101 may determine whether there is a combination of frequency bands that allows data transmission and/or reception to or from the first cellular network and data transmission and/or reception to or from the second cellular network to be performed simultaneously.

The electronic device 101 may store, on the memory 130, information related to the communication circuit 520 including a combination of frequency bands through which the communication circuit 520 can transmit and/or receive signals of different frequency bands simultaneously. Based on the measurement object (or, system information block (SIB)) received from the first cellular network, the measurement object (or, system information) received from the second cellular network, and/or the information related to the communication circuit 520, the electronic device 101 may determine whether there is a combination of frequency bands that allows data transmission/reception through the first cellular network and data transmission/reception through the second cellular network to be performed simultaneously.

Upon determining that there is no combination of frequency bands that allows data transmission/reception through the first cellular network and data transmission/reception through the second cellular network to be performed simultaneously (operation 940—No), at operation 950, the electronic device 101 may maintain the first mode.

The communication circuit 520 may support transmission of a signal of a first frequency band and transmission of a signal of a third frequency band simultaneously, the measurement object (or, system information) received from the first cellular network may include information indicating that there is a node supporting the first frequency band, and the measurement object (or, system information) received from the second cellular network may include information indicating that there is a node supporting the second frequency band. Based on the measurement object (or, system information) received from the first cellular network, the measurement object (or, system information) received from the second cellular network, and/or the information related to the communication circuit 520, the electronic device 101 may determine that there is no combination of connectable frequency bands among combinations of frequency bands (e.g., first frequency band and third frequency band) that allow data transmission through the first cellular network and data transmission through the second cellular network to be performed simultaneously.

The electronic device 101 may maintain the first mode. The electronic device 101 may not establish a connection to the second cellular network while maintaining the connection to the first cellular network.

The electronic device 101 may stand by until the connection to the first cellular network is released, and then establish a connection to the second cellular network.

Upon determining that there is a combination of frequency bands that allows data transmission/reception through the first cellular network and data transmission/reception through the second cellular network to be performed simultaneously (operation 940—Yes), at operation 960, the electronic device 101 may switch from the first mode to the second mode.

The communication circuit 520 may support transmission of a signal of a first frequency band and transmission of a signal of a second frequency band simultaneously, the measurement object (or, system information) received from the first cellular network may include information indicating that there is a node supporting the first frequency band, and the measurement object (or, system information) received from the second cellular network may include information indicating that there is a node supporting the second frequency band. Based on the measurement object (or, system information) received from the first cellular network, the measurement object (or, system information) received from the second cellular network, and/or the information related to the communication circuit 520, the electronic device 101 may determine whether there is a combination of connectable frequency bands (e.g., first frequency band and second frequency band) among combinations of frequency bands (e.g., first frequency band and second frequency band) that allow data transmission through the first cellular network and data transmission through the second cellular network to be performed simultaneously. Based on determining that there is a combination of connectable frequency bands (e.g., first frequency band and second frequency band), the electronic device 101 may control the communication circuit 520 to activate (or maintain) the connection to the first cellular network through the first frequency band and to activate the connection to the second cellular network through the second frequency band. If being connected to the first cellular network through a frequency band other than the first frequency band, the electronic device 101 may control the communication circuit 520 to connect to the first cellular network through the first frequency band.

In the second mode, the electronic device 101 may transmit or receive data to or from the first cellular network through the first frequency band, and may transmit or receive data to or from the second cellular network through the second frequency band.

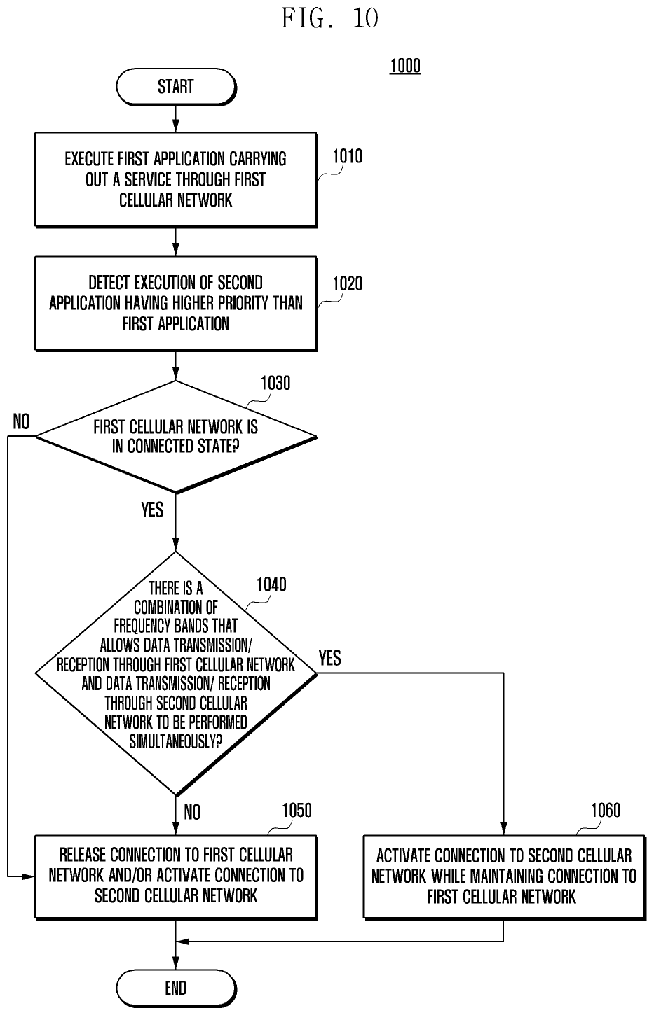

FIG. 10 is a flowchart 1000 illustrating operations of an electronic device that activates a connection to a second cellular network according to execution of an application having a relatively high priority according to an embodiment of the disclosure.

Referring to FIG. 10, at operation 1010, the electronic device (e.g., electronic device 101 in FIG. 1) may execute a first application that carries out a service through the first cellular network.

At operation 1020, the electronic device 101 may detect execution of a second application having a higher priority than the first application.

The second application may be an application that carries out a service through the second cellular network.

The priority of an application (or, service) may be determined in a variety of ways.

The priority of an application (or, service) may be set by the manufacturer of the application, or may be set (or, changed) according to the user's settings. For example, some applications (e.g., business applications) among applications pre-installed by the manufacturer of the electronic device 101 may have a higher priority than other applications.

The priority of an application (or, service) may be determined based on the characteristics of the application. For example, an application (or, service) that requires low latency or high transmission speed may have a higher priority than an application (or, service) that can be implemented with relatively high latency or low transmission speed. For another example, an application (or, service) that provides a real-time service (e.g., application installed on a vehicle in relation to autonomous driving) may have a higher priority than an application (or, service) that provides a non-real time service (e.g., application that reports the status of a vehicle). As another example, an application (or, service) that provides an emergency service (e.g., application related to 211 or 911 emergency) may have a higher priority than an application that provides a non-emergency service.

At operation 1030, the electronic device 101 may determine whether the first cellular network is in the connected state.

If the first cellular network is not in the connected state, the electronic device 101 may release the connection to the first cellular network and activate the connection to the second cellular network (operation 1050).

If the first cellular network is in the connected state (operation 1030—Yes), at operation 1040, the electronic device 101 may determine whether there is a combination of frequency bands that allows data transmission and/or reception to or from the first cellular network and data transmission and/or reception to or from the second cellular network to be performed simultaneously.

Upon receiving a request for activating the connection to the second cellular network, the electronic device 101 may determine whether there is a combination of connectable frequency bands among combinations of frequency bands that allow data transmission through the first cellular network and data transmission through the second cellular network to be performed simultaneously. Alternatively, before receiving a request for activating the connection to the second cellular network while being connected to the first cellular network, the electronic device 101 may determine in advance whether there is a combination of connectable frequency bands among combinations of frequency bands that allow data transmission through the first cellular network and data transmission through the second cellular network to be performed simultaneously.

Upon determining that there is no combination of frequency bands that allows data transmission through the first cellular network and data transmission through the second cellular network to be performed simultaneously (operation 1040—No), at operation 1050, the electronic device 101 may release the connection to the first cellular network and/or activate the connection to the second cellular network.

Based on the measurement object (or, system information) received from the first cellular network, the measurement object (or, system information) received from the second cellular network, and/or the information related to the communication circuit 520, the electronic device 101 may determine that there is no combination of connectable frequency bands among combinations of frequency bands that allow data transmission through the first cellular network and data transmission through the second cellular network to be performed simultaneously.

Upon determining that there is no combination of connectable frequency bands among combinations of frequency bands that allow data transmission through the first cellular network and data transmission through the second cellular network to be performed simultaneously, the electronic device 101 may release the connection to the first cellular network used by the first application with a relatively low priority and activate the connection to the second cellular network used by the second application with a relatively high priority. Releasing the connection to the first cellular network may include deactivating the IPDN between the first cellular network and the electronic device 101. Activating the connection to the second cellular network may include activating the IPDN between the second cellular network and the electronic device 101.

The electronic device 101 may carry out the service provided by the second application based on the data received through the IPDN between the second cellular network and the electronic device 101.

The electronic device 101 may transmit data to the second cellular network through the IPDN between the second cellular network and the electronic device 101.

As the execution of the second application ends, the electronic device 101 may deactivate the connection to the second cellular network and reactivate the connection to the first cellular network. The electronic device 101 may receive data over the first cellular network and may carry out the service provided by the first application based on the data received through the IPDN between the first cellular network and the electronic device 101.

Based on determining that there is a combination of frequency bands that allows data transmission through the first cellular network and data transmission through the second cellular network to be performed simultaneously (operation 1040—Yes), at operation 1060, the electronic device 101 may activate the connection to the second cellular network while maintaining the connection to the first cellular network.

Based on determining that there is a combination of connectable frequency bands (e.g., first frequency band and second frequency band) among combinations of frequency bands that allow data transmission through the first cellular network and data transmission through the second cellular network to be performed simultaneously, the electronic device 101 may control the communication circuit 520 to activate (or, maintain) the connection to the first cellular network via the first frequency band and to activate the connection to the second cellular network via the second frequency band.

The electronic device 101 may transmit and/or receive data related to the first application to or from the first cellular network through the first frequency band, and may transmit and/or receive data related to the second application to or from the second cellular network through the second frequency band.

When connected to the first cellular network through a frequency band other than the first frequency band, the electronic device 101 may control the communication circuit 520 to make a connection to the first cellular network through the first frequency band. The electronic device 101 may control the communication circuit 520 to release the connection to the first cellular network through the different frequency band and to make a connection to the first cellular network through the first frequency band.

When connected to the first cellular network in the non-standalone mode, the electronic device 101 may switch to the standalone mode. Data transmission is performed to the first cellular network via the first antenna 531 and the second antenna 533 in the non-standalone mode, so the electronic device 101 may enable data transmission to the second cellular network by switching from the non-standalone mode to the standalone mode.

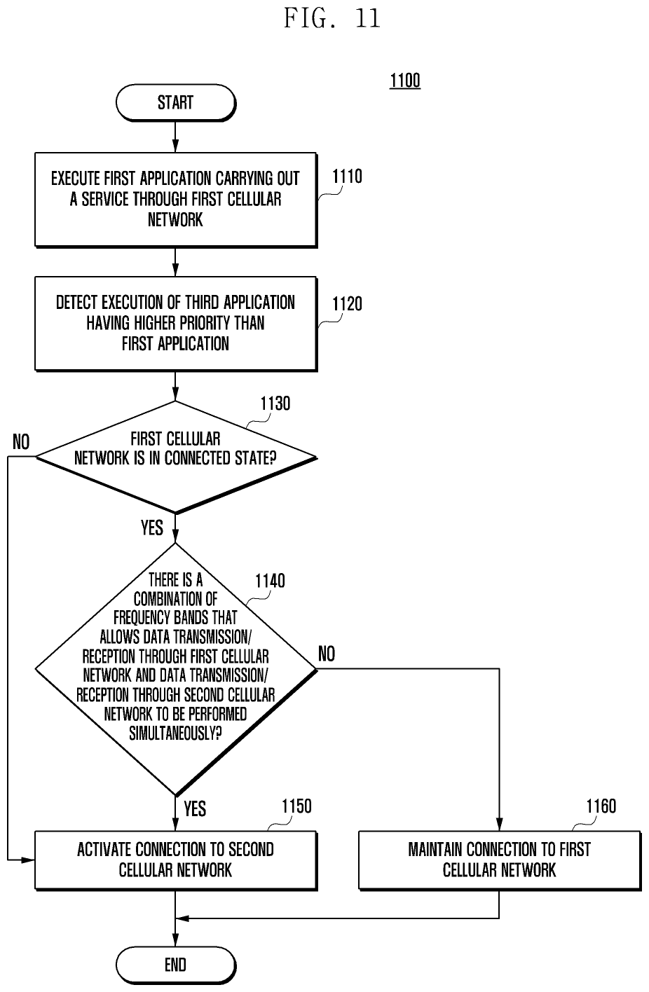

FIG. 11 is a flowchart 1100 illustrating operations of an electronic device that activates a connection to a second cellular network upon execution of an application having a relatively low priority according to an embodiment of the disclosure.

Referring to FIG. 11, at operation 1110, the electronic device (e.g., electronic device 101 in FIG. 1) may execute a first application that carries out a service through the first cellular network.

At operation 1120, the electronic device 101 may detect execution of a third application having a lower priority than the first application.

The second application may be an application that carries out a service over the second cellular network.

The priority of an application (or, service) may be determined in various ways.

The priority of an application (or, service) may be set by the manufacturer of the application, or may be set (or, changed) according to the user's settings. For example, some applications (e.g., business applications) among applications pre-installed by the manufacturer of the electronic device 101 may have a higher priority than other applications.

The priority of an application (or, service) may be determined based on the characteristics of the application. For example, an application (or, service) that requires low latency or high transmission speed may have a higher priority than an application (or, service) that can be implemented with relatively high latency or low transmission speed. For another example, an application (or, service) that provides a real-time service (e.g., application installed on a vehicle in relation to autonomous driving) may have a higher priority than an application (or, service) that provides a non-real time service (e.g., application that reports the status of a vehicle). As another example, an application (or, service) that provides an emergency service (e.g., application related to 211 or 911 emergency) may have a higher priority than an application that provides a non-emergency service.

At operation 1130, the electronic device 101 may check whether the first cellular network is in the connected state.

If the first cellular network is not in the connected state (operation 1130—No), the electronic device 101 may release the connection to the first cellular network and activate the connection to the second cellular network (operation 1150).

If the first cellular network is in the connected state (operation 1130—Yes), at operation 1140, the electronic device 101 may determine whether there is a combination of frequency bands that allows data transmission and/or reception to or from the first cellular network and data transmission and/or reception to or from the second cellular network to be performed simultaneously.

Upon receiving a request for activating the connection to the second cellular network, the electronic device 101 may determine whether there is a combination of connectable frequency bands among combinations of frequency bands that allow data transmission through the first cellular network and data transmission through the second cellular network to be performed simultaneously. Alternatively, before receiving a request for activating the connection to the second cellular network while being connected to the first cellular network, the electronic device 101 may determine in advance whether there is a combination of connectable frequency bands among combinations of frequency bands that allow data transmission through the first cellular network and data transmission through the second cellular network to be performed simultaneously.

Based on determining that there is a combination of frequency bands that allows data transmission through the first cellular network and data transmission through the second cellular network to be performed simultaneously (operation 1140—Yes), at operation 1150, the electronic device 101 may activate the connection to the second cellular network.

Based on determining that there is a combination of connectable frequency bands (e.g., first frequency band and second frequency band) among combinations of frequency bands that allow data transmission through the first cellular network and data transmission through the second cellular network to be performed simultaneously, the electronic device 101 may control the communication circuit 520 to activate (or, maintain) the connection to the first cellular network via the first frequency band and to activate the connection to the second cellular network via the second frequency band.

The electronic device 101 may transmit and/or receive data related to the first application to or from the first cellular network through the first frequency band, and may transmit and/or receive data related to the second application to or from the second cellular network through the second frequency band.

Upon determining that there is no combination of frequency bands that allows data transmission through the first cellular network and data transmission through the second cellular network to be performed simultaneously (operation 1140—No), at operation 1160, the electronic device 101 may maintain the connection to the first cellular network.

Based on determining that there is no combination of connectable frequency bands among combinations of frequency bands that allow data transmission through the first cellular network and data transmission through the second cellular network to be performed simultaneously, the electronic device 101 may maintain the connection to the first cellular network used by the first application with a relatively high priority, and may not make a connection to the second cellular network used by the second application with a relatively high priority.

The electronic device 101 may output information indicating that connection setup to the second cellular network is not possible on the execution screen of the second application.

As the execution of the first application ends, the electronic device 101 may deactivate the connection to the first cellular network and activate the connection to the second cellular network. The electronic device 101 may receive data through the second cellular network and carry out the service provided by the second application based on the received data.

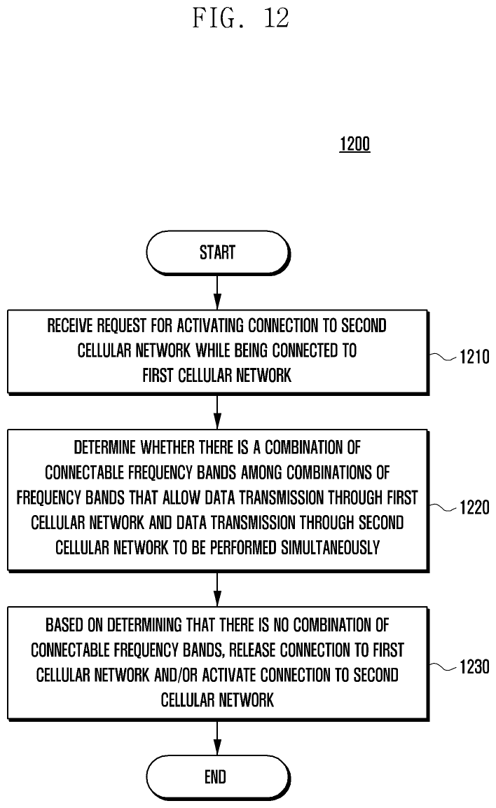

FIG. 12 is a flowchart 1200 illustrating an operation method of an electronic device according to an embodiment of the disclosure.

Referring to FIG. 12, at operation 1210, the electronic device (e.g., electronic device 101 in FIG. 1) may receive an activation request for the connection to the second cellular network while being connected to the first cellular network.

The electronic device 101 may be in a state of being connected to the first cellular network and being not connected to the second cellular network, and may operate in the first mode in which one of an application capable of providing various services through the first cellular network and an application capable of providing various services through the second cellular network is executed.

The first mode may be a mode in which the connection is made to one of the first cellular network and the second cellular network. When the electronic device 101 is in the first mode, the electronic device 101 may perform data communication through one network and may not perform data communication through the other cellular network (or, may stand by for data reception through the other cellular network). The cellular network that is not being used for data communication and the electronic device may be connected on a periodic basis for transmitting or receiving a paging message.

According to an example, the electronic device 101 may execute a first application that carries out a service via the first cellular network while being connected to the first cellular network. The electronic device 101 may receive an activation request for the connection to the second cellular network from the application processor 550 according to execution of a second application having a higher priority than the first application.

At operation 1220, the electronic device 101 may determine whether there is a combination of connectable frequency bands among combinations of frequency bands that allow data transmission through the first cellular network and data transmission through the second cellular network to be performed simultaneously.

Upon receiving a request for activating the connection to the second cellular network, the electronic device 101 may determine whether there is a combination of connectable frequency bands among combinations of frequency bands that allow data transmission through the first cellular network and data transmission through the second cellular network to be performed simultaneously. Alternatively, before receiving a request for activating the connection to the second cellular network while being connected to the first cellular network, the electronic device 101 may determine in advance whether there is a combination of connectable frequency bands among combinations of frequency bands that allow data transmission through the first cellular network and data transmission through the second cellular network to be performed simultaneously.

Based on the measurement object (or, system information) received from the first cellular network, the measurement object (or, system information) received from the second cellular network, and/or the information related to the communication circuit 520, the electronic device 101 may determine that there is no combination of connectable frequency bands among combinations of frequency bands that allow data transmission through the first cellular network and data transmission through the second cellular network to be performed simultaneously.

Based on determining that there is no combination of connectable frequency bands, at operation 1230, the electronic device 101 may release the connection to the first cellular network and/or activate the connection to the second cellular network.

Based on determining that there is no combination of connectable frequency bands among combinations of frequency bands that allow data transmission through the first cellular network and data transmission through the second cellular network to be performed simultaneously, the electronic device 101 may release the connection to the first cellular network used by the first application with a relatively low priority and activate the connection to the second cellular network used by the second application with a relatively high priority. Releasing the connection to the first cellular network may include deactivating the IPDN between the first cellular network and the electronic device 101. Activating the connection to the second cellular network may include activating the IPDN between the second cellular network and the electronic device 101.

The electronic device 101 may carry out the service provided by the second application based on the data received through the IPDN between the second cellular network and the electronic device 101.

The electronic device 101 may transmit data to the second cellular network through the IPDN between the second cellular network and the electronic device 101.

As the execution of the second application ends, the electronic device 101 may deactivate the connection to the second cellular network and reactivate the connection to the first cellular network. The electronic device 101 may receive data over the first cellular network and may carry out the service provided by the first application based on the data received through the IPDN between the first cellular network and the electronic device 101.

Based on determining that there is a combination of connectable frequency bands (e.g., first frequency band and second frequency band) among combinations of frequency bands that allow data transmission through the first cellular network and data transmission through the second cellular network to be performed simultaneously, the electronic device 101 may control the communication circuit 520 to activate (or, maintain) the connection to the first cellular network via the first frequency band and to activate the connection to the second cellular network via the second frequency band.

The electronic device 101 may transmit and/or receive data related to the first application to or from the first cellular network through the first frequency band, and may transmit and/or receive data related to the second application to or from the second cellular network through the second frequency band.

When connected to the first cellular network through a frequency band other than the first frequency band, the electronic device 101 may control the communication circuit 520 to make a connection to the first cellular network through the first frequency band. The electronic device 101 may control the communication circuit 520 to release the connection to the first cellular network through the different frequency band and to make a connection to the first cellular network through the first frequency band.

When connected to the first cellular network in the non-standalone mode, the electronic device 101 may switch to the standalone mode. Data transmission is performed to the first cellular network via the first antenna 531 and the second antenna 533 in the non-standalone mode, so the electronic device 101 may enable data transmission to the second cellular network by switching from the non-standalone mode to the standalone mode.

An electronic device according to various embodiments may include a first subscriber identity module storing a first profile associated with a first cellular network. The electronic device may include a second subscriber identity module storing a second profile associated with a second cellular network. The electronic device may include an application processor. The electronic device may include a communication circuit that supports transmission or reception of data through at least one cellular network among the first cellular network and the second cellular network. The electronic device may include a communications processor. The communication processor may be configured to receive, while being connected to the first cellular network, a request for activating the second cellular network from the application processor so as to carry out a service provided by a second application having a higher priority than the priority of a first application carrying out a service through the first cellular network. The communication processor may be configured to determine whether there is a combination of connectable frequency bands among combinations of frequency bands that allow the communication circuit to perform data transmission through the first cellular network and data transmission through the second cellular network simultaneously. Based on determining that there is no combination of connectable frequency bands, the communication processor may be configured to release the connection to the first communication network, and activate the connection to the second communication network.

In the electronic device according to various embodiments of the disclosure, based on determining that there is a combination of connectable frequency bands, the communication processor may be configured to activate the connection to the second cellular network while maintaining the connection to the first cellular network.

In the electronic device according to various embodiments of the disclosure, when the connection to the second communication network is released, the communication processor may be configured to activate the connection to the first communication network and to carry out a service through the first cellular network.

In the electronic device according to various embodiments of the disclosure, if there is a combination of connectable frequency bands and the frequency band associated with the first cellular network is not included in the combination of connectable frequency bands, the communication processor may be configured to change the frequency band associated with the first cellular network to a frequency band included in the combination of connectable frequency bands.

In the electronic device according to various embodiments of the disclosure, if there is a combination of connectable frequency bands and a connection is made to the first cellular network in the non-standalone mode, the communication processor may be configured to switch from the non-standalone mode to the standalone mode.

In the electronic device according to various embodiments of the disclosure, while being connected to the first cellular network, the communication processor may be configured to receive a request for activating the second cellular network from the application processor so as to carry out a service provided by a third application having a lower priority than the priority of the first application carrying out a service through the first cellular network. The communication processor may be configured to determine whether there is a combination of connectable frequency bands among combinations of frequency bands that allow the communication circuit to perform data transmission through the first cellular network and data transmission through the second cellular network simultaneously. Based on determining that there is no combination of connectable frequency bands, the communication processor may be configured to keep the second cellular network in a deactivated state.

In the electronic device according to various embodiments of the disclosure, when the connection to the first cellular network is released, the communication processor may be configured to activate the connection to the second cellular network.

In the electronic device according to various embodiments of the disclosure, the communication processor may be configured to determine whether there is a combination of connectable frequency bands based on the basis of a first measurement object received via the first cellular network, a second measurement object received via the second cellular network, and/or information related to the communication circuit.

In the electronic device according to various embodiments of the disclosure, the information related to the communication circuit may include information on frequency bands that enable the communication circuit to support simultaneous transmission of signals of different frequency bands.

In the electronic device according to various embodiments of the disclosure, if the communication circuit is capable of performing data transmission via the first cellular network and data transmission via the second cellular network simultaneously, the combinations of frequency bands may include a combination of a frequency band of the first cellular network and a frequency band of the second cellular network.

An operation method of the electronic device according to various embodiments of the disclosure may include receiving, while being connected to a first cellular network, a request for activating a second cellular network from an application processor so as to carry out a service provided by a second application having a higher priority than the priority of a first application carrying out a service through the first cellular network. The operation method of the electronic device may include determining whether there is a combination of connectable frequency bands among combinations of frequency bands that allow a communication circuit to perform data transmission through the first cellular network and data transmission through the second cellular network simultaneously. The operation method of the electronic device may include releasing the connection to the first communication network and activating the connection to the second communication network based on determining that there is no combination of connectable frequency bands.

The operation method of the electronic device according to various embodiments may further include activating the connection to the second cellular network while maintaining the connection to the first cellular network based on determining that there is a combination of connectable frequency bands.

The operation method of the electronic device according to various embodiments may further include activating, when the connection to the second communication network is released, the connection to the first communication network and carrying out a service through the first cellular network.

The operation method of the electronic device according to various embodiments may further include changing, if there is a combination of connectable frequency bands and the frequency band associated with the first cellular network is not included in the combination of connectable frequency bands, the frequency band associated with the first cellular network to a frequency band included in the combination of connectable frequency bands.

The operation method of the electronic device according to various embodiments may further include switching, if there is a combination of connectable frequency bands and a connection is made to the first cellular network in the non-standalone mode, from the non-standalone mode to the standalone mode.

The operation method of the electronic device according to various embodiments may include receiving, while being connected to the first cellular network, a request for activating the second cellular network so as to carry out a service provided by a third application having a lower priority than the priority of the first application carrying out a service through the first cellular network. The operation method of the electronic device may include determining whether there is a combination of connectable frequency bands among combinations of frequency bands that allow the communication circuit to perform data transmission through the first cellular network and data transmission through the second cellular network simultaneously. The operation method of the electronic device may further include keeping, based on determining that there is no combination of connectable frequency bands, the second cellular network in a deactivated state.

The operation method of the electronic device according to various embodiments may further include activating, when the connection to the first cellular network is released, the connection to the second cellular network.

In the operation method of the electronic device according to various embodiments of the disclosure, determining whether there is a combination of connectable frequency bands may include determining whether there is a combination of connectable frequency bands based on a first measurement object received via the first cellular network, a second measurement object received via the second cellular network, and/or information related to the communication circuit.

In the operation method of the electronic device according to various embodiments of the disclosure, the information related to the communication circuit may include information on frequency bands that enable the communication circuit to support simultaneous transmission of signals of different frequency bands.

In the operation method of the electronic device according to various embodiments of the disclosure, if the communication circuit is capable of performing data transmission via the first cellular network and data transmission via the second cellular network simultaneously, the combinations of frequency bands may include a combination of a frequency band of the first cellular network and a frequency band of the second cellular network.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a first subscriber identity module to store a first profile associated with a first cellular network;
a second subscriber identity module to store a second profile associated with a second cellular network;
an application processor;
a communication circuit configured to support transmission or reception of data through at least one cellular network among the first cellular network and the second cellular network;
memory storing one or more computer programs; and
a communications processor communicatively coupled to the first subscriber identity module, the second subscriber identity module, the application processor, the communication circuit, and the memory,
wherein the one or more computer programs include computer-executable instructions that, when executed by the communication processor individually or collectively, cause the electronic device to:
receive, while being connected to the first cellular network, a request for activating the second cellular network from the application processor so as to carry out a service provided by a second application having a higher priority than a priority of a first application carrying out a service through the first cellular network,
determine whether there is a combination of connectable frequency bands among combinations of frequency bands that allow the communication circuit to perform data transmission through the first cellular network and data transmission through the second cellular network simultaneously, and
release a connection to a first communication network, and activate a connection to a second communication network based on determining that there is no combination of connectable frequency bands.

2. The electronic device of claim 1, wherein the one or more computer programs further include computer-executable instructions that, when executed by the communication processor individually or collectively, cause the electronic device to activate the connection to the second cellular network while maintaining the connection to the first cellular network based on determining that there is a combination of connectable frequency bands.

3. The electronic device of claim 1, wherein in case that the connection to the second communication network is released, the one or more computer programs further include computer-executable instructions that, when executed by the communication processor individually or collectively, cause the electronic device to activate the connection to the first communication network and carry out a service through the first cellular network.

4. The electronic device of claim 1, wherein in case that there is a combination of connectable frequency bands and a frequency band associated with the first cellular network is not included in the combination of connectable frequency bands, the one or more computer programs further include computer-executable instructions that, when executed by the communication processor individually or collectively, cause the electronic device to change the frequency band associated with the first cellular network to a frequency band included in the combination of connectable frequency bands.

5. The electronic device of claim 1, wherein in case that there is a combination of connectable frequency bands and a connection is made to the first cellular network in a non-standalone mode, the one or more computer programs further include computer-executable instructions that, when executed by the communication processor individually or collectively, cause the electronic device to switch from the non-standalone mode to a standalone mode.

6. The electronic device of claim 1, wherein the one or more computer programs further include computer-executable instructions that, when executed by the communication processor individually or collectively, cause the electronic device to:
receive, while being connected to the first cellular network, a request for activating the second cellular network from the application processor so as to carry out a service provided by a third application having a lower priority than the priority of the first application carrying out a service through the first cellular network,
determine whether there is a combination of connectable frequency bands among combinations of frequency bands that allow the communication circuit to perform data transmission through the first cellular network and data transmission through the second cellular network simultaneously, and
maintain the second cellular network in a deactivated state based on determining that there is no combination of connectable frequency bands.

7. The electronic device of claim 6, wherein in case that the connection to the first cellular network is released, the one or more computer programs further include computer-executable instructions that, when executed by the communication processor individually or collectively, cause the electronic device to activate the connection to the second cellular network.

8. The electronic device of claim 1, wherein the one or more computer programs further include computer-executable instructions that, when executed by the communication processor individually or collectively, cause the electronic device to determine whether there is a combination of connectable frequency bands based on a first measurement object received via the first cellular network, a second measurement object received via the second cellular network, and/or information related to the communication circuit.

9. The electronic device of claim 8, wherein the information related to the communication circuit includes information about frequency bands that enable the communication circuit to support simultaneous transmission of signals of different frequency bands.

10. The electronic device of claim 1, wherein in case that the communication circuit is capable of performing data transmission via the first cellular network and data transmission via the second cellular network simultaneously, the combinations of frequency bands include a combination of a frequency band of the first cellular network and a frequency band of the second cellular network.

11. A method of operating an electronic device, the method comprising:
receiving, by the electronic device, while being connected to a first cellular network, a request for activating a second cellular network from an application processor so as to carry out a service provided by a second application having a higher priority than a priority of a first application carrying out a service through the first cellular network;
determining, by the electronic device, whether there is a combination of connectable frequency bands among combinations of frequency bands that allow a communication circuit to perform data transmission through the first cellular network and data transmission through the second cellular network simultaneously; and
releasing, by the electronic device, a connection to a first communication network and activating a connection to a second communication network based on determining that there is no combination of connectable frequency bands.

12. The method of claim 11, further comprising activating the connection to the second cellular network while maintaining the connection to the first cellular network based on determining that there is a combination of connectable frequency bands.

13. The method of claim 11, further comprising activating, in case that the connection to the second communication network is released, the connection to the first communication network and carrying out a service through the first cellular network.

14. The method of claim 11, further comprising changing, in case that there is a combination of connectable frequency bands and a frequency band associated with the first cellular network is not included in the combination of connectable frequency bands, the frequency band associated with the first cellular network to a frequency band included in the combination of connectable frequency bands.

15. The method of claim 11, further comprising switching, in case that there is a combination of connectable frequency bands and a connection is made to the first cellular network in a non-standalone mode, from the non-standalone mode to a standalone mode.

16. The method of claim 11, further comprising:
receiving, while being connected to the first cellular network, a request for activating the second cellular network from the application processor so as to carry out a service provided by a third application having a lower priority than the priority of the first application carrying out a service through the first cellular network;
determining whether there is a combination of connectable frequency bands among combinations of frequency bands that allow the communication circuit to perform data transmission through the first cellular network and data transmission through the second cellular network simultaneously; and
maintaining the second cellular network in a deactivated state based on determining that there is no combination of connectable frequency bands.

17. The method of claim 16, wherein in case that the connection to the first cellular network is released, activating the connection to the second cellular network.

18. The method of claim 11, further comprising determining whether there is a combination of connectable frequency bands based on a first measurement object received via the first cellular network, a second measurement object received via the second cellular network, and/or information related to the communication circuit.

19. One or more non-transitory computer-readable storage media storing one or more computer programs including computer-executable instructions that, when executed by a communications processor of an electronic device individually or collectively, cause the electronic device to perform operations, the operations comprising:
receiving, by the electronic device, while being connected to a first cellular network, a request for activating a second cellular network from an application processor so as to carry out a service provided by a second application having a higher priority than a priority of a first application carrying out a service through the first cellular network;
determining, by the electronic device, whether there is a combination of connectable frequency bands among combinations of frequency bands that allow a communication circuit to perform data transmission through the first cellular network and data transmission through the second cellular network simultaneously; and
releasing, by the electronic device, a connection to a first communication network and activating a connection to a second communication network based on determining that there is no combination of connectable frequency bands.

20. The one or more non-transitory computer-readable storage media of claim 19, the operations further comprising activating the connection to the second cellular network while maintaining the connection to the first cellular network based on determining that there is a combination of connectable frequency bands.
